(19) United States
(12) Patent Application Publication
(10) Pub. No.: US 2009/0190329 A1
(43) Pub. Date: Jul. 30, 2009

(54) LIGHT DIFFUSING PLATE, DIRECT-TYPE BACKLIGHT DEVICE AND LIQUID CRYSTAL DISPLAY SYSTEM

(75) Inventor: Keisuke TSUKADA, Tokyo (JP)

Correspondence Address: BIRCH STEWART KOLASCH & BIRCH, PO BOX 747, FALLS CHURCH, VA, 22040-0747, US

(73) Assignee: ZEON CORPORATION, Tokyo (JP)

(21) Appl. No.: 12/353,297

(22) Filed: Jan. 14, 2009

Related U.S. Application Data
(60) Provisional application No. 61/082,347, filed on Jul. 21, 2008.

(30) Foreign Application Priority Data
Jan. 15, 2008 (JP) 2008-005208

(51) Int. Cl. G02F 1/13357; G02B 5/02

(52) U.S. Cl. 362/97.2; 359/599; 362/97.1

(57) ABSTRACT

A direct-type backlight device has a reflection plate, a plurality of linear light sources disposed approximately in parallel to one another, and a light diffusion plate having a light incident surface which receives direct lights from the linear light sources and reflected lights which has emitted from the linear light sources and has been reflected on the reflection plate, and having a light emitting surface for emitting the light. Defining the mean distance between centers of the adjacent linear light sources as “a” (mm), the mean distance between the center of the linear light source and the light incident surface as “b” (mm), and the internal diameter of the linear light source as “r” (mm), the region obtained by projecting the internal diameter of the linear light source onto the light incident surface as X, and the region having a width (r×(b²+(a/2)²)^{1/2}/b) having a center on a position C obtained by projecting the center position of the adjacent linear light source onto the light incident surface as Y, a prism array XAA is formed on the region X on the light emitting surface, wherein the prism array XAA is composed of a plurality of concave linear prisms XA arranged approximately in parallel and extending along a lengthwise direction of the linear light sources. A prism array YBB is formed on the region Y on the light incident surface, wherein the prism array YBB is composed of a plurality of convex linear prisms YB arranged approximately in parallel and extending along the lengthwise direction of the linear light sources. The linear prism YB which composes the prism array YBB has a maximum arithmetic mean slope of 3 to 50°, the mean slope being with respect to a plain surface which is perpendicular to a thickness direction of the light diffusion plate.

### CROSS-REFERENCE TO RELATED APPLICATIONS

This application is based upon and claims the benefit of priority from Japanese Patent Application No. 2008-005208, filed Jan. 15, 2008; and U.S. Provisional Patent Application No. 61/082,347, filed Jul. 21, 2008, the entire contents of which are incorporated herein by reference.

### BACKGROUND OF THE INVENTION

1) Field of the Invention

The present invention relates to a light diffusion plate, a direct-type backlight device and a liquid crystal display device, and in particular relates to a light diffusion plate which can reduce luminance unevenness on a luminescent surface and can realize thickness reduction and energy saving of a direct-type backlight device, and such a direct-type backlight device, as well as a liquid crystal display device comprising the direct-type backlight device.

2) Description of the Related Art

As a backlight device for liquid crystal display devices, there have been used direct-type backlight devices comprising in this order a reflection plate, a plurality of linear light sources disposed approximately in parallel with the reflection plate, and a light diffusion plate having a light incident surface and a light emitting surface, wherein the light incident surface receives direct light from these linear light sources and reflected light that has been reflected on the reflection plate, and the light is then emitted from the light emitting surface which acts as a luminescent surface. In such a direct-type backlight device, a distance between a reflection surface of the reflection plate and the light incident surface of the light diffusion plate is usually about 18 to 22 mm and the distance between a center of the linear light source and the light incident surface of the light diffusion plate is usually about 15 mm.

Such a direct-type backlight device may easily cause a high luminance on a luminescent surface. However, on such a luminescent surface, cyclic luminance unevenness sometimes occurs since the luminance in a region directly above the linear light source on the luminescent surface (region defined by perpendicularly projecting the image of the linear light source onto the light diffusion plate) is high, and the luminance tends to be reduced as the distance from this directly above region increases. Addressing this issue, there has been disclosed a technique to reduce the luminance unevenness on the luminescent surface, wherein a stripe or dot pattern for adjusting the light amount is printed on the light diffusion plate, to reduce the amount of light passing through the region directly above the linear light source, thereby relatively increasing the amount of light passing through the region between the linear light sources (region defined by perpendicularly projecting the middle position between the adjacent linear light sources onto the light diffusion plate) (see Patent Document 1 (JP Hei-6-273760-A)).

As an example of an attempt to reduce the number of parts and to further improve the luminance unevenness of the direct-type backlight device, Patent Document 2 discloses a direct-type backlight device having a light diffusion plate whose both main surfaces are provided with a prism array comprising a plurality of linear prisms each having the same triangle-like cross-sectional surface shape (see Patent Document 2 (JP 2005-107020-A)).

In recent years, liquid crystal display devices are being desired to have thin shape. Thus, it is also required to reduce thickness of the direct-type backlight device itself. Specifically, those having a distance between the reflection surface of the reflection plate and the light incident surface of the light diffusion plate being about 10 mm are desired. In addition to reducing thickness, there has been made another attempt to reduce the number of light source units in the direct type backlight device, aiming at energy saving.

### SUMMARY OF THE INVENTION

Such a thickness reduction of the direct-type backlight device shortens the distance between a cold cathode tube and the light diffusion plate, whereby, regarding the light from the linear light sources toward the region between the linear light sources, the incident angle on the light incident surface of the light diffusion plate becomes large and its Fresnel reflectance is increased. In addition, a projection area of the linear light sources is increased. Therefore, there may arise a problem of more remarkable luminance unevenness on the luminescent surface. As another problem, reduction of the number of the light sources for use results in great difference between the luminance on the light emitting surface at the midpoint position of the adjacent light sources and the luminance on the light emitting surface at the position of the light source. Therefore, as discussed in the aforementioned issue of thickness reduction, luminance unevenness on the light emitting surface becomes more significant. Thus, the improvement of the luminance unevenness was insufficient by the method of printing the pattern for compensating the light amount on the predetermined region of the light diffusion plate as shown in Patent Document 1. When a thin device or reduced number of the light sources is desired, the prism array having the same shape on both main surfaces as shown in Patent Document 2 results in insufficient improvement of the luminance unevenness.

It is an object of the present invention to provide a light diffusion plate which can reduce the luminance unevenness on a luminescent surface and can realize a thin direct-type backlight device and energy saving, as well as to provide such a direct-type backlight device and a liquid crystal display device.

One aspect of the present invention is a light diffusion plate for disposing on a light emitting side of a light source, a planar view of said light diffusion plate being a rectangular shape, said light diffusion plate comprising: a plurality of regions X residing at an interval of “a” (mm) along a short side direction of said light diffusion plate, each of said region X having a width along said short side direction of 1.5 to 8.0 (mm), having a center position D of said width direction, and extending along a long side direction of said light diffusion plate, a region Y whose center is located at a position C which is the center position between the adjacent position D's, said region Y having a width of (0.1×a) to (0.6×a) (mm), and a region Z between said region X and region Y, wherein a main surface A of said light diffusion plate includes a region AX corresponding to said region X, a region AY corresponding to said region Y, and a region AZ corresponding to said region Z, wherein another main surface B of said light diffusion plate includes a region BX corresponding to said region X, a region BY corresponding to said region Y, and a region BZ corresponding to said region Z, wherein a prism array XAA is formed on said region AX, wherein said prism array XAA is composed of a plurality of linear prisms XA arranged approximately in parallel, extending along said long side direction of said light diffusion plate, wherein a prism array YBB is formed on said region BY, wherein said prism array YBB is composed of a plurality of linear prisms YB arranged approximately in parallel, extending along said long side direction of said light diffusion plate, and wherein said linear prism YB has a maximum arithmetic mean slope of 3 to 50°, said mean slope being with respect to a plain surface which is perpendicular to a thickness direction of said light diffusion plate.

The maximum arithmetic mean slope of the linear prism YB is preferably 3 to 50°, more preferably 5 to 45° and still more preferably 10 to 40° in terms of reducing thickness and preventing the luminance unevenness.

A numerical value “a” may be a constant numerical value or a numerical value with a variation. The width of the region Y is 0.1×a to 0.6×a, but may be 0.15×a to 0.50×a.

The arithmetic mean slope is the value obtained in accordance with Japanese Industrial Standards JIS B0601-1994. The maximum arithmetic mean slope of the linear prism is defined as follows. Taking up one linear prism in a certain range, measurements are performed within the inclined surface of the linear prism along a variety of directions and arithmetic mean slope thereof is calculated. Then the maximum value of the mean values among those measured in a variety of directions is taken as the maximum arithmetic mean slope. The arithmetic mean slope of each linear prism is obtainable with an ultra deep color 3D profile measuring microscope VK-9500 supplied from Keyence Corporation.

In each prism array, the maximum value of its centerline mean roughness Ra is usually 1 to 1,000 μm, preferably 2 to 500 μm and more preferably 3 to 100 μm when measured along the short side direction of the diffusion plate.

According to the present invention, the main surface A is arranged to be on the light emitting side (light emitting surface) and the main surface B is arranged to be on the light entering side (light incident surface), and the linear light source is disposed at the position corresponding to the region X, so that predetermined linear prisms are thereby disposed on the light emitting side in the region X (the place wherein the region AX and the region BX have been formed), whereby the linear prisms act so that the light which has emitted from the linear light source and arrived at the region X returns toward the linear light source. Further, linear prisms having predetermined mean slope are disposed on the light entering side of the region Y (the place wherein the region AY and the region BY have been formed), whereby the linear prisms act so that the light from the linear light source which has entered the region Y is led from the light incident surface to the light emitting surface in the region Y. Such action enables to reduce the amount of the light emission from the region directly above the linear light source (region X) that is the region with the highest luminance, and to increase the luminance between the linear light sources (region Y) that is the region with the lowest luminance. Therefore, luminance unevenness on the luminescent surface can be significantly reduced.

When the light diffusion plate according to the present invention is incorporated in a direct-type backlight device and when the direct-type backlight device is made thin so that the distance between the light incident surface of the light diffusion plate and a center position of the linear light source is 2.0 to 13.0 mm, Fresnel reflectance in the region between the linear light sources particularly increases sharply. Thus, some ingenuity in this part is important. Addressing thereto, according to the present invention, the part between the linear light sources, i.e., the region Y, is configured in a specific shape, which leads to reduction of Fresnel reflectance at the part, thereby being capable of providing a luminescent surface with no luminance unevenness even in the thin direct-type backlight device. Therefore, according to the present invention, the luminance unevenness on the luminescent surface can be reduced, and the direct-type backlight device having a thin thickness can be realized.

In the light diffusion plate, it is preferable that the linear prism XA and the linear prism YB have a cross-sectional surface shape of curved or polygonal configuration, wherein the cross-sectional surface is perpendicular to a lengthwise direction of the prism. The linear prism having such a configuration can be relatively easily molded by injection molding or extrusion molding which will be described later. The light diffusion plate used for the present invention may be produced by any method, although those produced by the following methods may be exemplified.

That is, the production may be performed by forming a prism array on a surface of a flat light diffusion plate, or by forming the prism array simultaneously and integrally with forming a flat portion (which may be referred to as a light diffusion plate base) which constitutes a substrate of the light diffusion plate.

Examples of the method of forming the prism array on the surface of the flat light diffusion plate may include a method of cutting and processing the surface of the flat light diffusion plate, a method of laminating or attaching a sheet having a concavo-convex structure such as a prism sheet having a desired shape on the flat light diffusion plate, a method of applying a photocurable resin or a thermosetting resin on the surface of the flat light diffusion plate, transferring the desired shape on the coating layer using a roll or a press mold and curing the coating film in that state, and an emboss method in which the surface of the flat light diffusion plate is pressed with a roll or a press mold having a desired shape.

Example of the method for forming the prism array simultaneously and integrally with forming the light diffusion plate base may include a casting method using a casting mold which can form the desired prism array, and an injection molding method using a metal mold which can form the desired prism array. The injection molding method and the casting method can be performed with simple steps because the prism array can be formed simultaneously with the light diffusion plate base. The casting method can be performed in the mold with which a plate can be molded, or can be continuously performed by running a raw material between two continuous belts while moving the belts. In the injection molding method, in order to enhance a shape transfer ratio, it is preferable to raise a mold temperature upon injecting the resin and rapidly cool the mold upon cooling. It is also possible to apply an injection compression molding method in which a mold therefor is open upon injecting the resin and subsequently the mold is closed.

In the present application, the linear prism is construed as including those having a cross-sectional surface shape of curved configuration such as circular arc and elliptical arc, specifically those having a lenticular convex portion (a so-called lens).

A refractive index of a material which composes the light diffusion plate is usually 1.40 to 1.70, preferably 1.45 to 1.65 and more preferably 1.50 to 1.60. In particular, it is preferable that the refractive index of the material of the prism portion adjacent to the linear prism falls into the aforementioned range.

A residual stress in the light diffusion plate used for the present invention is preferably 10 MPa or less, more preferably 5 MPa or less and still more preferably 3 MPa or less. A glass transition temperature (Tg) of the material which composes the light diffusion plate used for the present invention is preferably 90° C. or higher, more preferably 100° C. or higher and still more preferably 105° C. or higher. The upper limit for the glass transition temperature Tg of the material constituting the light diffusion plate may preferably be 400° C.

In the light diffusion plate, it is preferable that the cross-sectional surface shape is symmetric about an axis, wherein the axis is in parallel with the thickness direction of the light diffusion plate. Such a constitution facilitates easy molding process. In addition, such a constitution results in low luminance unevenness when the direct-type backlight device is observed from an oblique direction which is orthogonal to the linear light source, and symmetric view angles in the direction orthogonal to the linear light source.

The light diffusion plate may have a configuration wherein the prism array YAA is formed on the region AY, and the prism array YAA is composed of a plurality of the convex linear prisms YA arranged approximately in parallel and extending along the long side direction of the light diffusion plate, and wherein the arithmetic mean slope of the linear prisms YA which compose the prism array YAA is larger than the arithmetic mean slope of the linear prisms YB which compose the prism array YBB. Specifically, it is preferable that the difference therebetween is 2.5° or more.

The light diffusion plate may have a configuration wherein the shape of the prism array YAA and the shape of the prism array XAA are different from each other.

The light diffusion plate may have a configuration wherein the prism array ZAA is formed on the region AZ, and the prism array ZAA is composed of a plurality of the convex linear prisms ZA arranged approximately in parallel and extending along the long side direction of the light diffusion plate, and wherein the linear prism XA, the linear prism YA and the linear prism ZA have the same shape as one another.

The light diffusion plate may have a configuration wherein the prism array XBB is formed on the region BX, and the prism array XBB is composed of a plurality of the convex linear prisms XB arranged approximately in parallel and extending along the long side direction of the light diffusion plate, and wherein the shape of the prism array YBB and the shape of the prism array XBB can be different from each other.

The light diffusion plate may have a configuration wherein the prism array ZBB is formed on the region BZ, and the prism array ZBB is composed of a plurality of the convex linear prisms ZB arranged approximately in parallel and extending along the long side direction of the light diffusion plate, and wherein the linear prism XB, the linear prism YB and the linear prism ZB have the same shape as one another.

The light diffusion plate may have a configuration wherein at least one of the prism array XBB, the prism array YBB and the prism array ZBB includes two or more types of linear prisms each having a different arithmetic mean slope from another, and wherein an existence ratio of the two or more types of linear prisms is arranged so that the ratio of the linear prisms having a larger arithmetic mean slope is increased continuously or stepwisely as a distance from the center position in a width direction of the region BX is increased.

The light diffusion plate may have a configuration wherein at least one of the prism array XBB, the prism array YBB and the prism array ZBB is provided so that the arithmetic mean slope of the linear prism is increased continuously or stepwisely as a distance from the center position in a width direction of the region BX is increased and a distance toward the position C is decreased.

The light diffusion plate may have a configuration wherein at least one of the prism array XAA, the prism array YAA and the prism array ZAA includes two or more types of linear prisms having a different arithmetic mean slope, and wherein an existence ratio of the two or more types of linear prisms is arranged so that the ratio of the linear prisms having a larger arithmetic mean slope is increased continuously or stepwisely as a distance from the center position in a width direction of the region AX is increased.

The light diffusion plate may have a configuration wherein at least one of the prism array XAA, the prism array YAA and the prism array ZAA is arranged so that the arithmetic mean slope of the linear prism is increased continuously or stepwisely as a distance from the center position in a width direction of the region AX is increased and a distance toward the position C is decreased.

Another aspect of the present invention is directed to a direct-type backlight device comprising a reflection plate, a plurality of linear light sources disposed approximately in parallel to one another, and the aforementioned light diffusion plate disposed on a light emitting side of the linear light source, wherein the linear light source is disposed in a position opposed to the region BX.

Still another aspect of the present invention is directed to a liquid crystal display device comprising the aforementioned direct-type backlight device and a liquid crystal panel disposed on a light emitting side of this direct-type backlight device.

Still another aspect of the present invention is directed to a direct-type backlight device comprising in this order a reflection plate, a plurality of linear light sources disposed approximately in parallel with one another, and a light diffusion plate having a light incident surface and a light emitting surface wherein the light incident surface receives direct light from these linear light sources and reflected light that has been reflected on the reflection plate, and the light is then emitted from the light emitting surface, wherein the device has a mean distance between the centers of the adjacent linear light sources a (mm), a mean distance between the center of the linear light source and the light incident surface b (mm) and an internal space (a region containing an internal diameter portion, and extending in parallel with the linear light source) of the linear light source r (mm), wherein the region X is defined as a projected image of the internal diameter of the linear light source onto the light incident surface, and the region Y is defined as a region having a width r×(b²+(a/2)²)^{1/2}/b whose center is located at the position C which is defined by projecting the center position between the adjacent linear light sources onto the light incident surface, wherein the prism array XAA is formed on the region X in the light emitting surface and the prism array XAA is composed of a plurality of the concave linear prisms XA approximately in parallel and extending along the lengthwise direction of the linear light sources, wherein the prism array YBB is formed on the region Y of the light emitting surface and the prism array YBB is composed of a plurality of the convex linear prisms YB approximately in parallel and extending along the lengthwise direction of the linear light sources, and wherein the linear prism YB which composes the prism array YBB has the maximum arithmetic mean slope of 3 to 50°, the mean slope being with respect to a plain surface which is perpendicular to the thickness direction of the light diffusion plate.

The “region Y is defined as a region having a width r×(b²+(a/2)²)^{1/2}/b whose center is located at the position C” will be described hereinbelow. Firstly, a light coming from a certain linear light source toward a vicinity of a position A which is defined by projecting the center position of the linear light source onto the light incident surface will be discussed. Assuming that the linear light source has a width of r (mm), a perpendicularly irradiated region would be the region having the width r (mm) whose center is at the position A. Similarly discussing a light coming from the linear light source toward the vicinity of the position C, the region irradiated with the light coming from the linear light source having the width r (mm) to the light incident surface at a predetermined angle (incident angle θ) would be a region whose center is located at the position C and having a width r/cos θ (mm) that is, describing with the symbols a and b, the region of r×(b²+(a/2)²)^{1/2}/b. The reason why the width of the region Y1 is determined in such a manner will be described later.

According to the present invention, the predetermined linear prisms are formed on the light emitting side of the region X whereby the light which has emitted from the linear light source to the region X returns toward the inside of the direct-type backlight device. In addition, the linear prisms having a predetermined mean slope are formed on the light entering side of the region Y whereby the light from the linear light source which has entered the region Y is led from the light incident surface to the light emitting surface in the region Y. With such constitution, it may be possible to reduce the amount of the light emission from the region directly above the linear light source wherein the luminance is the highest, and it may also be possible to increase the luminance between the linear light sources wherein the luminance is the lowest, whereby the luminance unevenness on the luminescent surface can be further reduced. When reduction in thickness, etc. is attempted to an extent so that it satisfies a relationship (A) of 3.5≦a/b≦23.0 (further 3.5≦a/b≦19.0, 3.5≦a/b≦15.0), Fresnel reflectance in the region between the linear light sources particularly increases sharply. Thus, some ingenuity in this part is important. Addressing thereto, according to the present invention, this part is configured in a specific shape, which leads to reduction of Fresnel reflectance at the part, thereby being capable of providing a luminescent surface with no luminance unevenness even in the thin direct-type backlight device having the aforementioned range of relationship (A), by which reduction in luminance unevenness and reduction in thickness of the device can be achieved. Therefore, the direct-type backlight device of the present invention can achieve reduction in luminance unevenness on the luminescent surface, and reduction in thickness thereof.

According to the present invention, it is possible to realize the constitution wherein the mean distance a (mm) and the mean distance b (mm) satisfy the relationship (A) of 3.5≦a/b≦23.0, i.e., to realize reduction in thickness and in the number of the light sources. A direct-type backlight device with a reduced thickness may be realized by increasing a/b. However, in order to reduce luminance unevenness, it is important to set conditions of the device to be in a particular range. This will be described below.

FIG. 10 is a view for explaining Fresnel reflectance on the light incident surface, and is a cross-sectional view schematically showing the adjacent linear light sources and the light diffusion plate. FIG. 11 is a graph for explaining Fresnel reflectance on the light incident surface in the light diffusion plate having a refractive index of 1.53, and shows the relationship between the incident angle (degrees) and the reflectance. Mean values of reflectance values of s-wave light and p-wave light are shown.

As shown in FIG. 10, when the position defined by projecting the midpoint of the adjacent linear light source onto the light incident surface is designated as C, the incident angle (in the present application, the incident angle is the angle between the direction of the normal line on the light incident surface and the incident direction) of the light from the linear light source toward the position C becomes large, and the amount of the reflected light at the position C (Fresnel reflection) is increased. It is apparent as shown in FIG. 11 that, when the incident angle exceeds 60° (i.e., a/b=3.5), the reflectance is increased. Therefore, with an instance with an incident angle exceeding 60°, luminance at the position C may become low. Thus, the incident angle within the aforementioned range results in higher luminance in the region defined by perpendicularly projecting the linear light source, with respect to the luminance at the position C, which leads to the luminance unevenness on the luminescent surface.

Thus, by providing a layer to reduce light transmission in the region defined by projecting the linear light source onto the light diffusion plate, specifically by providing a predetermined prism array on the light emitting surface, it is possible to reduce the amount of the light emitted from the position D on the light diffusion plate. This way, by reducing the amount of the emitted light, it is possible to negate the luminance unevenness on the luminescent surface. However, when a prism array is not formed at the position C, the entered light is emitted at the same angle as the incident angle from the light diffusion plate. Addressing thereto, a predetermined prism array is provided on the position C to convert the direction of the emitted light to a front direction, whereby the luminance in the front direction in the position C can be increased to reduce the luminance unevenness on the luminescent surface.

FIG. 12 is a view for explaining the area of the projected light from the linear light source to the light emitting surface. As shown in FIG. 12, at the position C to which the light from the linear light source comes at the incident angle of θ, the area of the projected light from the linear light source to the light incident surface becomes 1/cos θ times larger than that at the position D to which the light from the linear light source comes at the incident angle of 0°. The luminance discussed herein is a light intensity per unit area, and thus the luminance on the luminescent surface decreases as the distance from the linear light sources is increased, i.e., as the incident angle is increased.

FIG. 13 is a graph showing the relationship between the incident angle (degrees) of the light from the linear light source to the light incident surface and a projected area onto the light incident surface. As shown in FIG. 13, the value of 1/cos θ rapidly increases when θ exceeds 85° (i.e., a/b=23.0). That is, when the incident angle exceeds 85°, the luminance between the linear light sources sharply decreases, which renders it difficult to keep low luminance unevenness. Thus, in the present invention, it is preferable that a/b is not more than 23.0.

According to the present invention, the main surface A is arranged to be on the light emitting side (light emitting surface) and the main surface B is arranged to be on the light entering side (light incident surface), and the linear light source is disposed at the position corresponding to the region AX, so that predetermined linear prisms are thereby disposed on the light emitting side in the region X (the place wherein the region AX and the region BX have been formed), whereby the linear prisms act so that the light which has emitted from the linear light source and arrived at the region X returns toward the linear light source. Further, linear prisms having predetermined mean slope are disposed on the light entering side of the region Y (the place wherein the region AY and the region BY have been formed), whereby the linear prisms act so that the light from the linear light source which has entered the region Y is led from the light incident surface to the light emitting surface in the region Y. Such action enables to reduce the amount of the light emission from the region directly above the linear light source (region X) that is the region with the highest luminance, and to increase the luminance between the linear light sources (region Y) that is the region with the lowest luminance. Therefore, luminance unevenness on the luminescent surface can be significantly reduced.

When the light diffusion plate according to the present invention is incorporated in a direct-type backlight device and when the direct-type backlight device is made thin so that the distance between the light incident surface of the light diffusion plate and a center position of the linear light source is 2.0 to 13.0 mm, Fresnel reflectance in the region between the linear light sources particularly increases sharply. Thus, some ingenuity in this part is important. According to the present invention, the part between the linear light sources, i.e., the region Y, is configured in a specific shape, which leads to reduction of Fresnel reflectance at the part, thereby being capable of providing a luminescent surface with no luminance unevenness even in the thin direct-type backlight device. Therefore, according to the present invention, the luminance unevenness on the luminescent surface can be reduced, and the direct-type backlight device having a thin thickness can be realized.

According to the direct type backlight device of the present invention, predetermined linear prisms are formed on the light emitting side of the region X and linear prisms having a predetermined mean slope are formed on the light incident surface of the region Y, which enables to reduce the amount of the light emission from the region directly above the linear light source that is the region with the highest luminance, and to increase the luminance between the linear light sources that is the region with the lowest luminance. Therefore, luminance unevenness on the luminescent surface can be further reduced. Such constitution enables provision of a luminescent surface without luminance unevenness even in a direct type backlight device having a thin thickness or a direct type backlight with a reduced number of the light sources used therein, wherein the relationship (A) of 3.0≦a/b≦23.0 (further 3.5≦a/b≦23.0, 3.5≦a/b≦19.0, 3.5≦a/b≦15.0) is satisfied. Therefore, the present invention has an effect of enabling a direct type backlight device with a reduced thickness, and energy saving of a direct type backlight device through reduction of the number of the light sources used therein.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a vertical cross-sectional view schematically showing the direct-type backlight device of the first embodiment.

FIG. 2 is a cross-sectional view specifically explaining a surface shape of the light diffusion plate used in the first embodiment.

FIG. 3 is a cross-sectional view specifically explaining a surface shape of the light diffusion plate used in the first embodiment.

FIG. 4 is a cross-sectional view specifically explaining a surface shape of the light diffusion plate used in the second embodiment.

FIG. 5 is a cross-sectional view specifically explaining a surface shape of the light diffusion plate used in the second embodiment.

FIG. 6 is a cross-sectional view specifically explaining a surface shape of the light diffusion plate used in the third embodiment.

FIG. 7 is a cross-sectional view specifically explaining a surface shape of the light diffusion plate used in the first Example.

FIG. 8 is a cross-sectional view specifically explaining a surface shape of the light diffusion plate used in the second Example.

FIG. 9 is a cross-sectional view specifically explaining a surface shape of the light diffusion plate used in the third Example.

FIG. 10 is a view for explaining Fresnel reflection on a light incident surface and is a vertical cross-sectional view schematically showing adjacent linear light sources and a light diffusion plate.

FIG. 11 is a graph explaining Fresnel reflection on the light incident surface in the light diffusion plate having a refractive index of 1.53, and shows a relationship between an incident angle (degrees) and a reflectance.

FIG. 12 is a cross-sectional view for explaining a projected area of a light which enters from the linear light source to the light incident surface.

FIG. 13 is a graph for explaining a relationship between the incident angle (degrees) from the linear light source to the light incident surface and the area projected to the light incident surface.

### BEST MODE FOR CARRYING OUT THE INVENTION

### First Embodiment

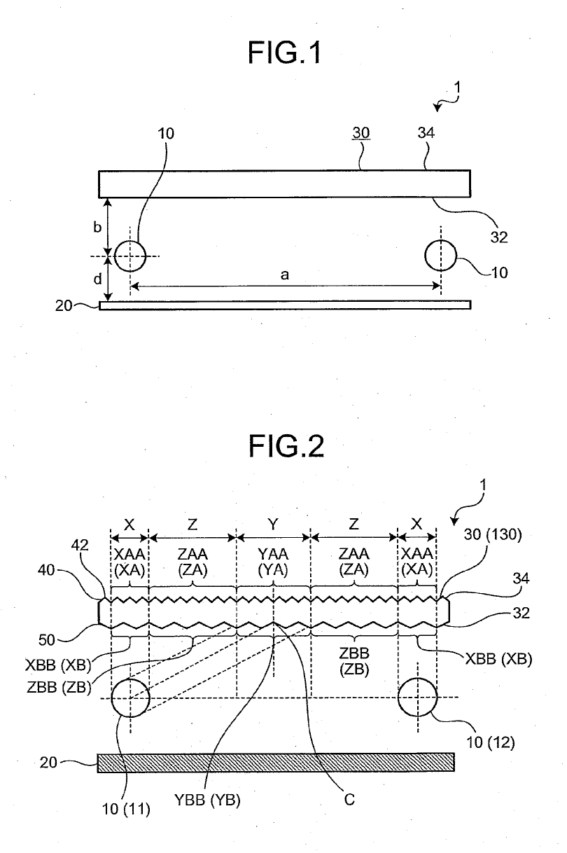

A direct-type backlight device according to a first embodiment of the present invention will be described hereinbelow with reference to drawings. FIG. 1 is a vertical cross-sectional view schematically showing the direct-type backlight device according to the present embodiment. As shown in FIG. 1, the direct-type backlight device 1 comprises in this order a reflection plate 20, a plurality of linear light sources 10 disposed approximately in parallel to one another, and a light diffusion plate 30 having a light incident surface 32 (corresponding to a main surface B) which receives direct light from the linear light sources and reflected light which has emitted from the linear light sources 10 and then reflected on the reflection plate 20, and also having a light emitting surface 34 (corresponding to a main surface A) for emitting the light.

In the present description, unless otherwise indicated, upper and lower directions mean, respectively, the upper and lower directions when the direct-type backlight device is placed so that its light emitting surface extends in a horizontal direction facing upper side. These directions respectively correspond to the upper and lower directions in each drawing. In the present specification, what is meant by that the directions of a plurality of constituents are “approximately parallel” includes, in addition to a parallel relationship, a relationship with a deviation to an extent within which the effect of the present invention is not deteriorated, e.g., a relationship making an angle within ±10°.

The linear light sources 10 are light sources configured in a form of straight (linear) tubes. It is preferable in terms of luminance evenness to use cold cathode fluorescent lamps (CCFL) in a form of straight tube. The linear light source 10 is not limited to the cold cathode fluorescent lamp, but also external electrode fluorescent lamps (EEFL), xenon lamps, xenon mercury lamps, thermal hot cathode fluorescent lamps, light emitting diodes (LED) arranged along a line, and a combination of LED and light guides may be used. An external diameter of the linear light source 10 is usually 2 to 20 mm and preferably 3 to 10 mm. An internal diameter “r” of the linear light source 10 is usually 1 to 19 mm and preferably 2 to 9 mm. Such diameters contribute to reduce thickness of the direct-type backlight device.

In addition to the straight shape, the shape of the linear light source 10 may also be a U-shape including two straight tubes approximately in parallel which are connected with a connecting tube having an approximately semicircular shape; an N-shape including three straight tubes approximately in parallel which are connected with two connecting tubes having an approximately semicircular shape to configure one tube; and a W-shape including four straight tubes approximately in parallel which are connected with three connecting tubes having an approximately semicircular shape to configure one tube.

The number of the linear light sources 10 is not particularly limited. For example, when the direct-type backlight device is used for a liquid crystal display device of 32 inches, the number may be an even number such as 24, 22, 20, 10, 16, 14, 12, 0, 4 and 2 or an odd number. When the linear light source is the U-shaped, N-shaped or W-shaped one as described above, its number is counted by the number of the straight portion of the tube.

The mean distance “a” between the centers of the adjacent linear light sources 10 is usually 10 to 50 mm and preferably 15 to 40 mm. When the number of the light sources used therein is reduced, the distance may be usually 10 to 150 mm, and preferably 15 to 100 mm. Adjustment of the mean distance within the aforementioned range brings about advantages such as reduction of the electric power consumption of the direct-type backlight device, easy assembly of the device, and reduced luminance unevenness on the luminescent surface. In terms of luminance uniformity on the direct-type backlight device (ratio of the maximum luminance with respect to the minimum luminance on the luminescent surface of the direct-type backlight device), it is preferable that the distance between the centers of the adjacent linear light sources is approximately constant (in the range of the mean distance ±5%). However, the distance does not have to be constant; the distance may be randomly varied, or may have a regularity in which the distance is increased or decreased continuously or stepwisely toward a particular position. The particular position may be, for example, a position at one long edge of the rectangular light diffusion plate, or a position on the light diffusion plate corresponding to a center place including a line connecting center positions of opposed short edges.

The mean distance b (mm) between the center of the linear light source 10 and the light incident surface 32 of the light diffusion plate 30 may be designed taking into consideration the thickness and the luminance uniformity of the direct-type backlight device, and may be 2 to 13 mm and is preferably 3 to 10 mm. By adjusting the mean distance b within the aforementioned range, it is possible to reduce the luminance unevenness, to prevent the reduction of a luminescence efficiency of the lamp and to realize a direct-type backlight device with reduced thickness. In the present embodiment, a plurality of the linear light sources 10 are disposed so that the mean distance b (mm) to the light incident surface 32 is approximately constant for all of the linear light sources. “Approximately constant” means (maximum value of the mean distance b (mm))/(minimum value of the mean distance b) (mm)≦1.3, although a plurality of the linear light sources may be disposed so that some linear light sources are closer to the light incident surface 32 than other linear light sources. For example, the distances may be random, or may have a regularity in which the distance is increased or decreased toward a particular position. The particular position may be, for example, one long edge of the rectangular light diffusion plate, or a center place including the line connecting center positions of opposed short edges.

The reflection plate 20 is a plate member which reflects the light emitted from the linear light source 10. As the material of the reflection plate 20, resins in white or silver color and metals may be used, and the resin is preferable for reducing weight. The color of the reflection plate 20 is preferably for reducing the luminance unevenness. However, in order to achieve well-balanced luminance and luminance uniformity, those having a combination of white and silver colors may be used as the material for the reflection plate 20.

The reflection plate may have, on the region located between the linear light sources, a protruding portion which protrudes to the light diffusion plate and extends along the lengthwise direction of a plurality of the linear light sources. It is preferable that the protruding portion is provided on an approximately intermediate position between the adjacent linear light sources. The shape of the cross-sectional surface in the crosswise direction of the protruding portion is not particularly limited, and examples thereof may include an isosceles triangle, an isosceles trapezoid, a shape obtained by cutting a circle, a shape obtained by cutting an ellipse with a line in parallel with the short axis, a shape obtained by cutting an ellipse with a line in parallel with the long axis, a shape obtained by combining downward convex curves to be line-symmetric and a shape obtained by combining upward convex curves to be line-symmetric. Apex portions of these shapes may be sharp or round. The triangle shape is preferable in terms of luminance uniformity and production easiness. It is preferable that the shape of the cross-sectional surface of the protruding portion is line-symmetric about the line perpendicular to the thickness direction of the light diffusion plate. Such a constitution may realize reduction in the luminance unevenness on the light emitting surface in the light diffusion plate. The protruding portions may be a continuous ridge or a non continuous structure such as a range of pyramids. Continuous structure is preferable because of further improvement of the luminance uniformity. Examples of the method for installing the protruding portion may include a method of painting a metal frame with the protruding portion with a white or silver paint, a method of attaching a white or silver reflection sheet on a metal frame with the protruding portion, a method of folding a white or silver flat reflection sheet and installing it on a flat metal frame and a method of molding a white or silver resin using a mold having a predetermined shape.

The light diffusion plate 30 is a plate member which diffuses and emits the incident light. As a material for the light diffusion plate 30, it is possible to use glasses, a mixture of two or more species of resins which do not tend to be mutually compatible, a transparent resin in which a light diffusing agent is dispersed, and one species of transparent resin. Among them, the resin is preferable in terms of light weight and good moldability. One species of the transparent resin is preferable in terms of facile luminance enhancement. A transparent resin in which a light diffusing agent is dispersed is preferable in terms of good adjustability of the total light transmittance and the haze.

The transparent resin is a resin having a total light transmittance of 70% or more measured in accordance with JIS K7361-1 using a plate having smooth surfaces on both sides and having a thickness of 2 mm, and examples thereof may include polyethylene, propylene-ethylene copolymers, polypropylene, polystyrene, copolymers of an aromatic vinyl monomer and alkyl (meth)acrylic acid ester having a lower alkyl group, polyethylene terephthalate, terephthalic acid-ethylene glycol-cyclohexane dimethanol copolymer, polycarbonate, acryl resins and resins having an alicyclic structure. (Meth) acrylic acid means acrylic acid and methacrylic acid.

Among them, resins having a water absorption ratio of 0.25% or less, e.g., polycarbonate, polystyrene, copolymers of the aromatic vinyl based monomer with alkyl (meth)acrylic acid ester having the lower alkyl group containing 10% or more of the aromatic vinyl monomer, and resins having an alicyclic structure are preferable as the transparent resin, because of low tendency of shape changing due to moisture absorption, which enables production of a light diffusion plate having a large size with less warp.

The resin having an alicyclic structure is further preferable because of good fluidity which enables efficient production of a large sized light diffusion plate. The mixture of the resin having an alicyclic structure and the light diffusing agent may be suitably used because the mixture has both high transmittance and high diffusibility required for the light diffusion plate, and gives a product with good chromaticity.

The resin having an alicyclic structure is a resin having an alicyclic structure in its main chain and/or side chain. The resin having the alicyclic structure in its main chain is preferable in terms of mechanical strength and heat resistance. Examples of the alicyclic structure may include saturated cyclic hydrocarbon (cycloalkane) structures and unsaturated cyclic hydrocarbon (cycloalkene, cycloalkine) structures. Cycloalkane structures and cycloalkene structures are preferable, and among them, the cycloalkane structure is the most preferable in terms of mechanical strength and heat resistance. Number of carbon atoms which compose the alicyclic structure are usually 4 to 30, preferably 5 to 20 and more preferably 5 to 15 in terms of well balanced mechanical strength, heat resistance and a molding property of the light diffusion plate.

The ratio of the repeating unit having an alicyclic structure in the resin having an alicyclic structure may be appropriately selected depending on a purpose of use, and is usually 50% by weight or more, preferably 70% by weight or more and more preferably 90% by weight or more. Extremely low ratio of the repeating unit having an alicyclic structure is not preferable because heat resistance is reduced thereby. Repeating units other than the repeating unit having an alicyclic structure in the resin having an alicyclic structure is appropriately selected depending on the purpose of use.

Specific examples of the resin having an alicyclic structure may include (1) norbornene polymers such as ring-opening polymers of norbornene monomers, ring-opening copolymers of the norbornene monomer and other monomers ring-opening copolymerizable therewith, hydrogenated products thereof, addition polymers of the norbornene monomer, and addition copolymers of a norbornene based monomer and other monomers ring-opening copolymerizable therewith; (2) monocyclic olefin polymers and hydrogenated products thereof; (3) cyclic conjugated diene polymers and hydrogenated products thereof; and (4) vinyl alicyclic hydrocarbon polymers such as polymers of a vinyl alicyclic hydrocarbon based monomer, copolymers of the vinyl alicyclic hydrocarbon based monomer and other monomers copolymerizable therewith, hydrogenated products thereof, hydrogenated polymers of a vinyl aromatic monomer having hydrogenated aromatic rings, and hydrogenated copolymers of the vinyl aromatic monomer and other monomers copolymerizable therewith having hydrogenated aromatic rings.

In terms of heat resistance and mechanical strength, preferable among them are the norbornene polymers and the vinyl alicyclic hydrocarbon polymers, particularly are hydrogenated products of the ring-opening polymers of the norbornene monomers, hydrogenated products of the ring-opening copolymers of the norbornene monomer and the other monomers ring-opening copolymerizable therewith, hydrogenated polymers of the vinyl aromatic monomer having hydrogenated aromatic rings, and hydrogenated copolymers of the vinyl aromatic monomer and the other monomers copolymerizable therewith having hydrogenated aromatic rings.

The light diffusing agent is particles having a nature to diffuse a light ray and is broadly classified into an inorganic filler and an organic filler. Examples of the inorganic filler may include silica, aluminium hydroxide, aluminium oxide, titanium oxide, zinc oxide, barium sulfate, magnesium silicate and mixtures thereof. Examples of the organic filler may include acryl resins, polyurethane, polyvinyl chloride, polystyrene resins, polyacrylonitrile, polyamide, polysiloxane resins, melamine resins and benzoguanamine resins. Among them, as the organic filler, fine particles composed of the polystyrene resin, the polysiloxane resin and crosslinked products thereof are preferable in terms of high diffusibility, high heat resistance and no coloration (yellowing) upon molding. Among them, the fine particle composed of the crosslinked product of the polysiloxane resin is more preferable in terms of more excellent heat resistance.

Examples of the shape of the light diffusing agent may include spherical, cubic, needle, bar, spindle, platy, scale and fibrous shapes, and among them, the spherical shape is preferable because directions of the light diffused thereby may be isotropic. The light diffusing agent is uniformly dispersed in the transparent resin for use.

The ratio of the light diffusing agent to be dispersed in the transparent resin may be appropriately selected depending on the thickness of the light diffusion plate and the interval between the linear light sources, and is usually adjusted so that the total light transmittance is preferably 60 to 98% and more preferably 65 to 95%. Adjusting the total light transmittance within the aforementioned suitable range, it is possible to further enhance the luminance and the uniformity ratio of luminance.

The total light transmittance is the value obtained by the measurement using an integrating sphere mode color difference turbidity meter in accordance with JIS K7361-1, as to a plate having flat surfaces on both sides and a thickness of 2 mm. The haze is the value obtained by the measurement in accordance with JIS K7136, as to a plate having flat surfaces on both sides and a thickness of 2 mm.

The thickness of the light diffusion plate is preferably 0.4 to 5 mm and more preferably 0.8 to 4 mm. Adjusting the thickness of the light diffusing plate within the aforementioned suitable range, it is possible to reduce a flexure due to the plate's own weight, and to enable easy molding. The mean distance “d” between the center of the linear light source 10 and the reflection plate 20 is usually 1.5 to 5 mm and preferably 2 to 4 mm. The size of the light diffusion plate is suitably 17 inches (height 212 mm×width 376 mm) to 100 inches (height 1245 mm×width 2214 mm) and preferably 32 inches (height 398 mm×width 708 mm) to 65 inches (height 809 mm×width 1439 mm).

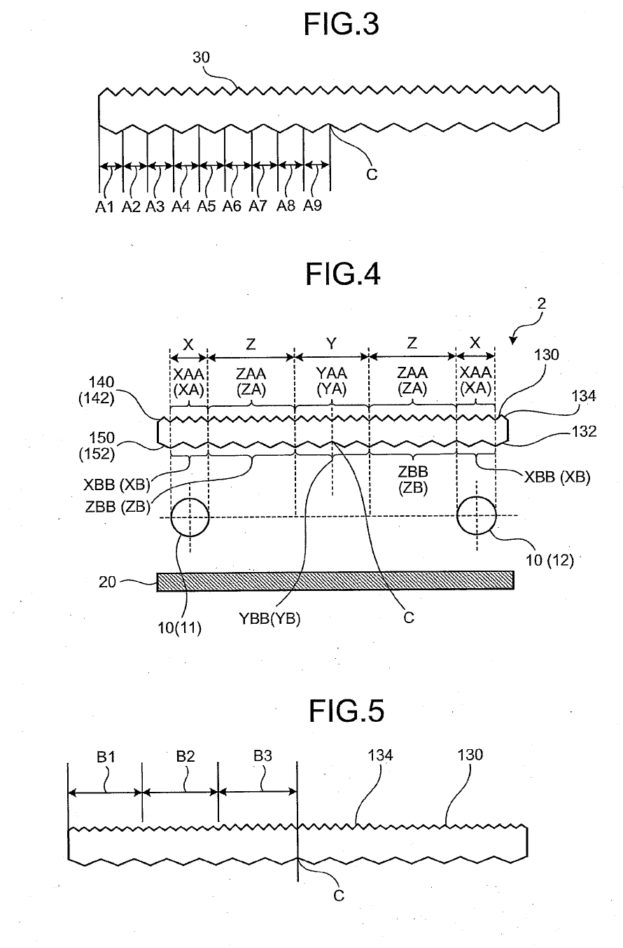

Subsequently, an outer configuration of the light diffusion plate 30 will be described. FIGS. 2 and 3 are cross-sectional views specifically explaining a surface shape of the light diffusion plate 30. Among a plurality of the linear light sources 10, only two adjacent linear light sources 11 and 12 are partially shown in FIG. 2.

As shown in FIG. 2, the light diffusion plate 30 comprises the light incident surface 32 which receives the light from the linear light sources 11 and 12, and the light emitting surface 34 from which the light which has entered from the light incident surface 32 is emitted in a diffusing manner. The light diffusion plate 30 may be segmented into a region X, a region Y and a region Z corresponding to relative location of the linear light sources 10. The region X is the region defined by projecting the internal space (a region containing an internal diameter portion) of the linear light sources 11 and 12 onto the light incident surface 32 of the light diffusion plate 30. The region Y is the region having the width r×(b²+(a/2)²)^{1/2}/b whose center is located at the position C which is defined by projecting the center position between the adjacent linear light sources 11 and 12 onto the light incident surface 32. The region Z is the remaining region other than the region X and the region Y, and is specifically the region between the region X and the region Y.

On the light diffusion plate 30 of the present embodiment, a prism array 40 having a cross-sectional surface shape like saw teeth is formed over the entire surface of the light emitting surface 34. The prism array 40 is composed of a plurality of linear prisms 42 each having a convex cross-sectional surface shape extending along the lengthwise direction of the linear light sources 10. The linear prisms are aligned adjoining to each other. That is, when the prism array 42 is segmented into a prism array XAA formed on the region X (corresponding to a region AX), a prism array YAA formed on the region Y (corresponding to a region AY) and a prism array ZAA formed on the region Z (corresponding to a region AZ), each of these prism arrays XAA, YAA and ZAA is composed of a plurality of linear prisms XA, YA and ZA, respectively, having approximately the same shape. Each of respective linear prisms XA, YA and ZA has a shape whose cross-sectional surface perpendicular to its lengthwise direction is an isosceles triangle. The arithmetic mean slope of each linear prism is usually 25 to 55° and preferably 30 to 50°.

On the light diffusion plate 30 of the present embodiment, a prism array 50 whose shape is different depending on its location are formed on the light incident surface 32. Specifically as shown in FIG. 3, the position directly above the linear light source 11 is defined as a starting point, and the area therefrom to the position C is divided into 9 segments A1 to A9. The width of each segment may be equal or different. The number of the divided segments does not have to be 9 but may be, e.g., 3 or 17. The concavo-convex shapes of the segments A1 to A9 in FIG. 3 are drawn as the same ones, but they are actually different as described above.

Each segment A1 to A9 is provided with a prism array comprising a plurality of linear prisms which are of one type, or a prism array comprising a plurality of linear prisms which are of a plurality of types at a predetermined existing ratio (existing number), each type having a different arithmetic mean slope with respect to the plain surface perpendicular to the thickness direction of the light diffusion plate. Each linear prism has a shape whose cross-sectional surface perpendicular to its lengthwise direction is an isosceles triangle.

More specifically, the segment A1 is provided with linear prisms AA alone having an arithmetic mean slope of 5°. The segment A2 is provided with a combination of linear prisms AA having an arithmetic mean slope of 5° and linear prisms AB having an arithmetic mean slope of 10° at an existence ratio of 1:1. The segment A3 is provided with linear prisms AB alone having an arithmetic mean slope of 10°. The segment A4 is provided with a combination of linear prisms AB having an arithmetic mean slope of 10° and linear prisms AC having an arithmetic mean slope of 15° at an existence ratio of 1:1. The segment A5 is provided with linear prisms AC alone having an arithmetic mean slope of 150. The segment A6 is provided with a combination of linear prisms AC having an arithmetic mean slope of 15° and linear prisms AD having an arithmetic mean slope of 20° at an existence ratio of 1:1. The segment A7 is provided with linear prisms AD alone having an arithmetic mean slope of 20°. The segment A8 is provided with a combination of linear prisms AD having an arithmetic mean slope of 20° and linear prisms AE having an arithmetic mean slope of 25° at an existence ratio of 1:1. The segment A9 is provided with linear prisms AE alone having an arithmetic mean slope of 25°.

Examples of the manner of providing prisms in combination may includes a disposal in regular manner, e.g., an alternate disposal of the linear prisms AA and the linear prisms AB, and a random disposal. “Provided with a combination of linear prisms AA having an arithmetic mean slope of 5° and linear prisms AB having an arithmetic mean slope of 10° at an existence ratio of 1:1.” means that the length calculated by summing bottom width of all linear prisms AA is approximately equal (the difference thereof within 5%) to the length calculated by summing bottom width of all linear prisms AB.

When the prism array 50 is segmented into a prism array XBB formed on the region X and composed of a plurality of linear prisms XB, a prism array YBB formed on the region Y and composed of a plurality of linear prisms YB and a prism array ZBB formed on the region Z and composed of a plurality of linear prisms ZB, these prism arrays XBB, YBB and ZBB have different shapes from one another. As described above, a plurality of linear prisms are formed on the light incident surface, and each linear prism has an arithmetic mean slope of 5 to 25°. Therefore, the linear prisms YB which compose the prism array YBB satisfy the relationship that the maximum arithmetic mean slope is 3 to 50°.

The linear prisms are formed so that the arithmetic mean slope of the linear prisms formed on the light incident surface is smaller than the arithmetic mean slope of the linear prisms formed on the light emitting surface. Satisfying such a relationship, it is possible to achieve both improvement in luminance on the luminescent surface and reduction in luminance unevenness.

As the height of the linear prisms, Ra(max) is usually 1 to 1,000 μm, preferably 2 to 500 μm and more preferably 3 to 100 μm, wherein Ra (max) is the maximum value of the centerline mean roughness Ra values measured on the light incident surface or the light emitting surface of the light diffusion plate and along a variety of directions. The width of the linear prism is usually 10 to 500 μm, preferably 20 to 400 μm and more preferably 30 to 300 μm.

According to the direct-type backlight device of the present embodiment, since linear prisms having a predetermined shape on predetermined position as described above, the luminance unevenness on the luminescent surface can be sufficiently reduced even when the direct-type backlight device satisfies the range of 3.5≦a/b≦23.0, or when the direct-type backlight device satisfies the range of 3.5≦a/b≦19.0, or particularly when the direct-type backlight device satisfies the range of 3.5≦a/b≦15.0, in other words, even when the direct-type backlight device has a reduced thickness.

### Second Embodiment

The direct-type backlight device 2 in the present embodiment is different from the first embodiment only in outer configuration of the light diffusion plate. Thus, only different points of the present embodiment will be mainly discussed, and discussion on the other points will be simplified. The same symbol indicates the same one or the same or corresponding constitution. FIGS. 4 and 5 are cross-sectional views specifically explaining the surface shape of a light diffusion plate 130.

As shown in FIG. 4, on the light diffusion plate 130 of the present embodiment, a prism array 150 having a cross-sectional surface shape like saw teeth is formed over the entire surface of the light incident surface 132. The prism array 150 is composed of a plurality of linear prisms 152 having a convex cross-sectional surface shape extending along the lengthwise direction of linear light sources 10. The linear prisms are aligned adjoining to each other. When the prism array 150 is segmented into a prism array XBB formed on the region X, a prism array YBB formed on the region Y and a prism array ZBB formed on the region Z, each of these prism arrays XBB, YBB and ZBB comprises a plurality of linear prisms XB, YB and ZB, respectively, having approximately the same shape. Each of linear prisms XB, YB and ZB has a shape whose cross-sectional surface perpendicular to its lengthwise direction is an isosceles triangle. The maximum value of the arithmetic mean slope values of each linear prism is usually 3 to 50° and preferably 5 to 45°.

On the light diffusion plate 130 of the present invention, a prism array 140 whose shape is different depending on its location is formed on a light emitting surface 134. Specifically, as shown in FIG. 5, defining the position directly above the linear light source 11 as the starting point, interval to the position C is divided into 3 segments B1 to B3. The width of the segments B1 and B2 are mutually equal and the width of the segment B3 is larger than those of the segments B1 and B2.

Each of segments B1 to B3 is provided with a prism array comprising at a predetermined existence ratio a plurality of various types of linear prisms having different arithmetic mean slope with respect to the plain surface perpendicular to the thickness direction of the light diffusion plate. Each linear prism has a shape whose cross-sectional surface perpendicular to its lengthwise direction is an isosceles triangle. Each segment is composed of two types of linear prisms.

More specifically, the segment B1 is provided with a combination of linear prisms BA having an arithmetic mean slope of 37.5° and linear prisms BB having an arithmetic mean slope of 10° at an existence ratio of 1:1. The segment B2 is provided with a combination of linear prisms BA having an arithmetic mean slope of 37.5° and linear prisms BB having an arithmetic mean slope of 10° at an existence ratio of 2:1. That is, the number of the linear prisms BA is greater in the segment B2. The segment B3 is provided with a combination of linear prisms BA having an arithmetic mean slope of 37.5° and linear prisms BB having an arithmetic mean slope of 10° at an existence ratio of 3:1. Therefore, the light incident surface has two or more types of linear prisms each having a different cross-sectional shape, and the existence ratio of the two or more types of linear prisms is changed stepwisely as distance from the position defined by projecting the center position of the linear light source onto the light diffusion plate increases.

In the present embodiments, the same effects as in the first embodiment can be obtained.

### Third Embodiment

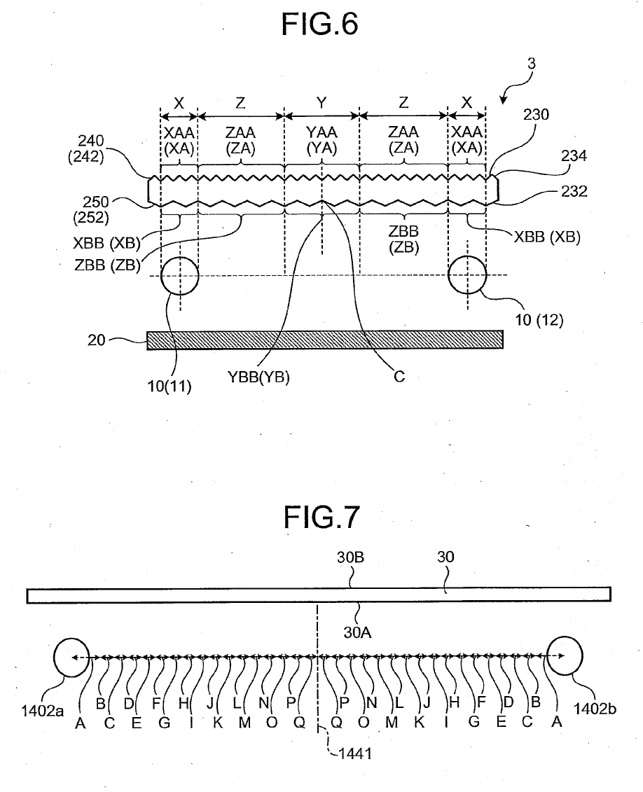

A direct-type backlight device 3 in the present embodiment is different from the first embodiment only in outer configuration of the light diffusion plate. FIG. 6 is a cross-sectional view specifically explaining the surface shape of a light diffusion plate 230. On the light diffusion plate 230 in the present embodiment, a prism array 250 having a cross-sectional surface shape like saw teeth is formed over the entire surface of the light incident surface 232. The prism array 250 is composed of a plurality of linear prisms 252 having a convex cross-sectional surface, extending along the lengthwise direction of the linear light sources 10. The linear prisms are aligned adjoining to each other. When the prism array 250 is segmented into a prism array XBB formed on the region X, a prism array YBB formed on the region Y and a prism array ZBB formed on the region Z, each of these prism arrays XBB, YBB and ZBB is composed of a plurality of linear prisms XB, YB and ZB, respectively, having approximately the same shape. Each of respective linear prisms XB, YB and ZB has a shape whose cross-sectional surface perpendicular to its lengthwise direction is an isosceles triangle. The maximum value of the arithmetic mean slope values of each linear prism is usually 3 to 50° and preferably 5 to 40°.

On the light diffusion plate 230 in the present embodiment a prism array 240 having a cross-sectional surface shape like saw teeth is formed over the entire surface of the light emitting surface 234. The prism array 240 is composed of a plurality of linear prisms 242 each having a convex cross-sectional surface shape extending along the lengthwise direction of the linear light sources 10. The linear prisms are aligned adjoining to each other. When the prism array 240 is segmented into a prism array XAA formed on the region X, a prism array YAA formed on the region Y and a prism array ZAA formed on the region Z, each of these prism arrays XAA, YAA and ZAA is composed of a plurality of linear prisms XA, YA and ZA, respectively, having approximately the same shape. Each of respective linear prisms XA, YA and ZA has a shape whose cross-sectional surface perpendicular to its lengthwise direction is an isosceles triangle. The maximum value of the arithmetic mean slope values of each linear prism is usually 15 to 50° and preferably 20 to 45°.

The relationship between the arithmetic mean slope of the linear prisms formed on the light incident surface and the arithmetic mean slope of the linear prisms formed on the light emitting surface is not particularly limited. However, it is preferable that the arithmetic mean slope of the linear prisms formed on the light incident surface is smaller than the arithmetic mean slope of the linear prisms formed on the light emitting surface. Having such a constitution, the light emitted to the portion directly above the linear light source is reflected by the prism on the emitting side and thereby tends to be returned toward the inside of the direct-type backlight devise, contributing to the reduction of the luminance at this position, whereas the light emitted from the linear light source to the position C is relatively largely refracted by the gradual slope of the incident surface. In addition, the reduction of Fresnel reflectance and the increase of the projected area of the linear light source can be prevented, and further the direction of the light is converted to a direction which is close to a front direction (direction in parallel with the thickness direction of the light diffusion plate), contributing to increase of the luminance on the position C by the prisms on the emitting side whose slope is larger than those on the entering side. Thus, overall luminance unevenness can be thereby reduced.

### Variant Example

The present invention is not limited to the aforementioned embodiments.

In the aforementioned embodiments, the cross-sectional shape of the linear prism was an isosceles triangle. However, the shape does not have to be the isosceles triangle and may be for example a rectangular shape such as a trapezoid, a polygon such as a pentagon and a hexagon and a heptagon, a shape obtained by providing a curve such as a circular arc, an elliptical arc, a parabolic arc or skewed curve thereof to a tip of the polygon, or a shape containing the aforementioned curve. The cross-sectional shape of the linear prism was the shape which is symmetric about the thickness direction in the light diffusion plate as an axis, although the shape is not limited thereto. However, the cross sectional surface shape is preferably in a symmetric shape because the design therefor becomes easy thereby and no luminance unevenness occurs when observed from either a right or left oblique direction.

In the aforementioned embodiments, the linear prisms were formed so that their bottom portions were aligned in an adjoining manner. However, the present invention is not limited thereto. The linear prisms may be present with an interval from one another, i.e., a smooth region (flat surface) may be present between the adjacent linear prisms. In this case, the width of the smooth regions may be uniform, or may be changed continuously or stepwisely as distance from the linear light sources increases.

In the aforementioned embodiments, the existence ratio of the linear prisms was changed stepwisely as distance from the linear light sources increases. However, the ratio may be changed continuously, and the slope angle of the linear prism may be increased continuously or stepwisely.

In the present invention, the surface of each linear prism may be smoothened or roughened. Roughened surface may render the emitting direction more diverse in the appropriate range and may also improve mold releasing property from the mold upon forming the plate. From the aforementioned point of view, an arithmetic mean height Ra on the surface of the linear prism is preferably 0.01 μm or more and 3 μm or less, more preferably 0.02 μm or more and 2 μm or less and still more preferably 0.05 μm or more and 1 μm or less. Roughening may be given on all or a part of the linear prism structure, and may be given on an entire or a part of the surface of each linear prism.

In the direct-type backlight device, an optical sheet may be disposed on the light emitting side of the light diffusion plate. The number of the optical sheet to be provided may be one or more. It is preferable that the optical sheets include one or more sheets having a function as a light ray direction converting element. The sheet having a function as a light ray direction converting element is a sheet wherein the incident angle of the incident light thereinto and the emitting angle of the emitting light therefrom become different. It is sufficient therefor that the direction of the peak of the incident light and the direction of the peak of the emitting light are different. The emitting light may be diffused compared to the incident light and may have a distribution. As the optical sheet, a commercially available prism sheet or diffusion sheet may be used. Any of these sheets may be used alone or these sheets may be used in combination.

In addition, it is preferable that the optical sheet includes one or more reflection type polarizers. It is preferable that the reflection type polarizer is provided on the light emitting side. The reflecting light polarizer for use may include the following: a reflecting light polarizer utilizing a difference in reflection coefficient components based on Brewster's angle (for example, one described in Japanese Patent Application National Publication No. H6-508449 A); a reflecting light polarizer utilizing selective reflection property of Cholesteric liquid crystal, e.g., a multilayer article of a film made of the Cholesteric liquid crystal and a ¼ wavelength plate (for example, one described in Japanese Patent Application Laid-open No. H3-45906 A); a reflecting light polarizer provided with a minute metallic linear pattern (for example, one described in Japanese Patent Application Laid-open No. H2-308106 A); a reflecting light polarizer in which at least two kinds of high polymer films are laminated and that utilizes anisotropy in reflection coefficient due to anisotropic refractive index (for example, one described in Japanese Patent Application National Publication No. H9-506837 A); a reflecting light polarizer made of a high polymer film having an “island-sea” structure configured with at least two types of high polymers, which utilizes anisotropy in reflection coefficient due to anisotropic refractive index (for example, one described in U.S. Pat. No. 5,825,543); a reflecting light polarizer in which particles are dispersed in a high polymer film, and that utilizes anisotropy in reflection coefficient due to anisotropic refractive index (for example, one described in Japanese Patent Application National Publication No. H11-509014 A); and a reflecting light polarizer in which inorganic particles are dispersed in a high polymer film, and that utilizes anisotropy in reflection coefficient based on difference in diffusing ability depending on particle sizes (for example, one described in Japanese Patent Application Laid-open No. H9-297204 A).

The direct-type backlight device of the present invention may be suitably used for the liquid crystal display devices having a variety of display modes such as twisted nematic (TN) modes, super twisted nematic (STN) modes, hybrid alignment nematic (HAN) modes, vertical alignment (VA) modes, multi-domain vertical alignment (MVA) modes, in-plane switching (IPS) modes and optically compensated birefringence (OCB) modes.

### EXAMPLES

The present invention will be described in more detail with reference to the following Examples, but the present invention is not limited to these Example at all.

### Example 1

A reflection plate and a light diffusion plate for a direct-type backlight device were produced.

### (Reflection Plate)

A reflection sheet (E6SV supplied from Toray Industries, Inc.) was attached to inside surface of an aluminium case of an internal width 729 mm, length 404 mm and depth 8 mm, to prepare a reflection plate.

(Light Diffusion Plate)

Mold parts having a predetermined shape were used in an injection molding machine (mold clamping force: 9,810 KN). With the machine, an alicyclic olefin polymer (Zeonor 1420R supplied from Zeon Corporation) as a raw material was moled under the conditions of a cylinder temperature at 320° C., a pressure keeping at 50 MPa, a pressure keeping time for 3 seconds and a mold temperature at 130° C., to obtain a light diffusion plate. The resulting light diffusion plate was a 730 mm×405 mm flat plate having a thickness of 2 mm. On one side of the light diffusion plate, a predetermined pattern of a concavo-convex structure was formed. In the pattern, a plurality of linear prisms having a cross-sectional surface shape of an isosceles triangle having an apex angle of 100° (corresponding to an arithmetic mean slope of 40°) were arranged approximately in parallel with a pitch of 70 μm. On the other side of the light diffusion plate, another predetermined pattern was formed. In the pattern, a plurality of sorts of linear prisms (having an isosceles triangle cross-sectional shape), each sort having a different apex angle from another, were disposed at a predetermined mixed ratio. These predetermined patterns will be described later. One of the surfaces was polished and a residual stress was measured, and its maximum value was 0.3 MPa. Not only in this Example but also in all of Examples and Comparative Examples in the present application, the linear prisms on the light incident surface and the light emitting surface in the light diffusion plate were provided to become approximately parallel with the long side direction of the light diffusion plate and with the longitudinal direction of light sources. The refractive index of Zeonor 1420R was 1.53, and its total light transmittance measured based on JIS K7361-1 using a plate having flat surfaces on both sides and having a thickness of 2 mm was 92%.

The aforementioned concavo-convex structure is explained with reference to FIG. 7 and Table 1.

A state wherein the light diffusion plate is mounted in the direct-type backlight device was considered. An area corresponding to a distance from the center of a cold cathode tube 1402a to a midpoint 1441 between the center of the cold cathode tube 1402a and the center of an adjacent cold cathode tube 1402b was divided into 17 zones of A to Q. The range of each zone (distance in right and left direction in FIG. 7) was adjusted as shown in Table 1. Each zone on the light incident surface of the light diffusion plate was provided with linear prisms each having a cross-sectional surface of a triangle shape having an apex angle 140° (corresponding to the arithmetic mean slope of 20°) to 170° (corresponding to the arithmetic mean slope of 5°) at a mixed ratio as shown in Table 1. The pitch of the linear prisms was 70 μm.

TABLE 1

| | Width | Mixing ratio | | | | |
|---|---|---|---|---|---|---|
| | (mm) | 170° | 160° | 150° | 140° | 130° |
| A | 3.5 | 1 | | | | |
| B | 0.56 | 3 | 1 | | | |
| C | 0.28 | 1 | 1 | | | |
| D | 0.28 | 1 | 3 | | | |
| E | 0.77 | | 1 | | | |
| F | 0.56 | | 3 | 1 | | |
| G | 0.28 | | 1 | 1 | | |
| H | 0.28 | | 1 | 3 | | |
| I | 0.77 | | | 1 | | |
| J | 0.56 | | | 3 | 1 | |
| K | 0.28 | | | 1 | 1 | |
| L | 0.28 | | | 1 | 3 | |
| M | 0.77 | | | | 1 | |
| N | 0.56 | | | | 3 | 1 |
| O | 0.28 | | | | 1 | 1 |
| P | 0.28 | | | | 1 | 3 |
| Q | 1.21 | | | | | 1 |

Table 1 shows an assignment of a convex portion in a repeating unit of the concavo-convex structure. For example, in the case of D region, a concavo-convex structure including one convex of a triangle having an apex angle of 170° and three convexes of triangles each having an apex angle of 160° constitutes one unit, and this unit is repeated.

Sixteen cold cathode tubes having an internal diameter “r” of 3 mm and an external diameter of 4 mm were attached in parallel with the internal width direction of the reflection plate. The distance “a” between the centers of the cold cathode tubes was 23 mm and the distance from the reflection plate to the center of the cold cathode tube was 3.5 mm. A vicinity of a cathode section was fixed with a silicone sealant, and an inverter was attached. Subsequently, on the reflection plate composed of the aluminium case with the attached reflection sheet, the light diffusion plate was placed, so that the side on which the pattern shown in Table 1 had been formed faces the thermal hot cathode tube side. At that time, the distance “b” between the center of the cold cathode tube and the light incident surface of the light diffusion plate was 4.5 mm. Since the distance “b” is much larger than the height of the linear prism, the distance “b” may be measured on the basis of either the top or the bottom of the linear prism.

In this backlight device, the width of the region Y (r×(b²+(a/2)²)^{1/2}/b) is 8.2 mm, a/b is 5.1, the maximum arithmetic mean slope of the prisms on the light incident surface in the region Y is 15°, and the maximum arithmetic mean slope of the prisms on the light emitting surface in the region Y is 40°.

On the light emitting side of this light diffusion plate, a diffusion sheet (188GM3 supplied from Kimoto Co., Ltd.), a prism sheet (BEFTII-10T supplied from Sumitomo 3M Ltd.) and the diffusion sheet ((188GM3 supplied from Kimoto Co., Ltd.) were placed in this order as the optical sheets.

Then, a tube current of 5.5 mA was applied to the resulting direct-type backlight device, for turning on the device. The luminance in a front direction was measured at 100 points with equal intervals along the long side direction of the aluminium case on the centerline in the crosswise direction of the aluminium case using a two dimensional color distribution measurement apparatus. The measured value of the central luminance was 5,720 cd/m². The mean luminance in the front direction (LA) and the luminance unevenness (LU) were obtained in accordance with the following mathematical formulae 1 and 2. The luminance unevenness was 0.5%. Their results are shown in Table 2.

Mean luminance: LA=(L1+L2)/2 (Mathematical formula 1)

Luminance unevenness: LU=((L1−L2)/LA)×100 (Mathematical formula 2)

L1: Mean of local maximum values directly above plurality of thermal hot cathode tubes

L2: Mean of local minimum values between the local maximum values

The luminance unevenness is an indicator which indicates evenness of the luminance, and when the luminance is poor, its numerical value becomes large.

No warp of the light diffusion plate was observed during tests, and even when the lighting was continued after the tests, the luminance unevenness was not increased.

TABLE 2

| | | Unit | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|---|---|
| Back- | Distance between | mm | 23.0 | 23.0 | 23.0 | 23.0 | 24.5 | 24.5 | 23.0 | 23.0 | 23.0 |
| light | centers of | | | | | | | | | | |
| con- | linear light | | | | | | | | | | |
| struc- | sources “a” | | | | | | | | | | |
| tion | Distance between | mm | 4.5 | 4.5 | 4.5 | 6.5 | 6.0. | 6.0 | 6.5 | 6.5 | 4.5 |
| | linear light | | | | | | | | | | |
| | source center | | | | | | | | | | |
| | and light | | | | | | | | | | |
| | incident surface | | | | | | | | | | |
| | “b” | | | | | | | | | | |
| | Distance between | mm | 3.5 | 3.5 | 3.5 | 3.5 | 5.0 | 5.0 | 3.5 | 3.5 | 3.5 |
| | liniear light | | | | | | | | | | |
| | source center | | | | | | | | | | |
| | and reflection | | | | | | | | | | |
| | plate “d” | | | | | | | | | | |
| | Distance between | mm | 8.0 | 8.0 | 8.0 | 10.0 | 11.0 | 11.0 | 10.0 | 10.0 | 8.0 |
| | light incident | | | | | | | | | | |
| | surface and | | | | | | | | | | |
| | reflection plate | | | | | | | | | | |
| | Outer diameter | mm | 4.0 | 4.0 | 4.0 | 4.0 | 4.0 | 4.0 | 4.0 | 4.0 | 4.0 |
| | of linear light | | | | | | | | | | |
| | source “R” | | | | | | | | | | |
| | Inner diameter | mm | 3.0 | 3.0 | 3.0 | 3.0 | 3.0 | 3.0 | 3.0 | 3.0 | 3.0 |
| | of linear light | | | | | | | | | | |
| | source “r” | | | | | | | | | | |
| | Optical sheet 1 | — | None | None | None | None | None | None | Reflection | None | None |
| | (distant from | | | | | | | | polarizer | | |
| | light diffusion | | | | | | | | | | |
| | plate) | | | | | | | | | | |
| | Optical sheet 2 | — | None | None | None | Diffusion | Diffusion | Diffusion | Diffusion | None | None |
| | | | | | | sheet | sheet | sheet | sheet | | |
| | Optical sheet 3 | — | Diffusion | Diffusion | Diffusion | Diffusion | Diffusion | Prism | Diffusion | Diffusion | Diffusion |
| | | | sheet | sheet | sheet | sheet | sheet | sheet | sheet | sheet | sheet |
| | Optical sheet 4 | — | Prism | Prism | Prism | Prism | Prism | Diffusion | Diffusion | Prism | Prism |
| | | | sheet | sheet | sheet | sheet | sheet | sheet | sheet | sheet | sheet |
| | Optical sheet 5 | — | Diffusion | Diffusion | Diffusion | Diffusion | Diffusion | Diffusion | Diffusion | Diffusion | Diffusion |
| | (near light | | sheet | sheet | sheet | sheet | sheet | sheet | sheet | sheet | sheet |
| | diffusion plate) | | | | | | | | | | |
| Light | Light emitting | ° | 100° | 105&160° | 100° | 130° | 100° | 105° | 110° | 120° | 100° |
| diffu- | surface pattern | | | mix | | | | | | | |
| sion | Light incident | ° | 130-170° | 130° | Flat/ | 120° | 130° | 135° | 130° | 130° | 130-170° |
| plate | surface pattern | | mix | | trape- | | | | | | mix |
| | | | | | zoid/130° | | | | | | |
| | | | | | mix | | | | | | |
| | Region Y (light | ° | 40 | 37.5 | 40 | 25 | 40 | 37.5 | 35 | 30 | 40 |
| | emitting) | | | | | | | | | | |
| | maximum slope | | | | | | | | | | |
| | Region Y (light | ° | 15 | 25 | 25 | 30 | 25 | 22.5 | 25 | 25 | 15 |
| | incident) | | | | | | | | | | |
| | maximum slope | | | | | | | | | | |
| | r × | mm | 8.2 | 8.2 | 8.2 | 6.1 | 6.8 | 6.8 | 6.1 | 6.1 | 8.2 |
| | (b² + (a/2)2)^{1/2}/b | | | | | | | | | | |
| | Residual stress | MPa | 0.3 | 0.3 | 0.3 | 0.3 | 0.3 | 0.3 | 0.3 | 0.3 | 13 |
| Re- | Luminance | cd/m² | 5720 | 5660 | 5780 | 5400 | 5450 | 5830 | 5480 | 5610 | 5720 |
| sults | Luminance | % | 0.5 | 0.6 | 0.8 | 1.3 | 1.2 | 1 | 1.1 | 1.2 | 0.5 |
| | unevenness | | | | | | | | | | |

### Example 2

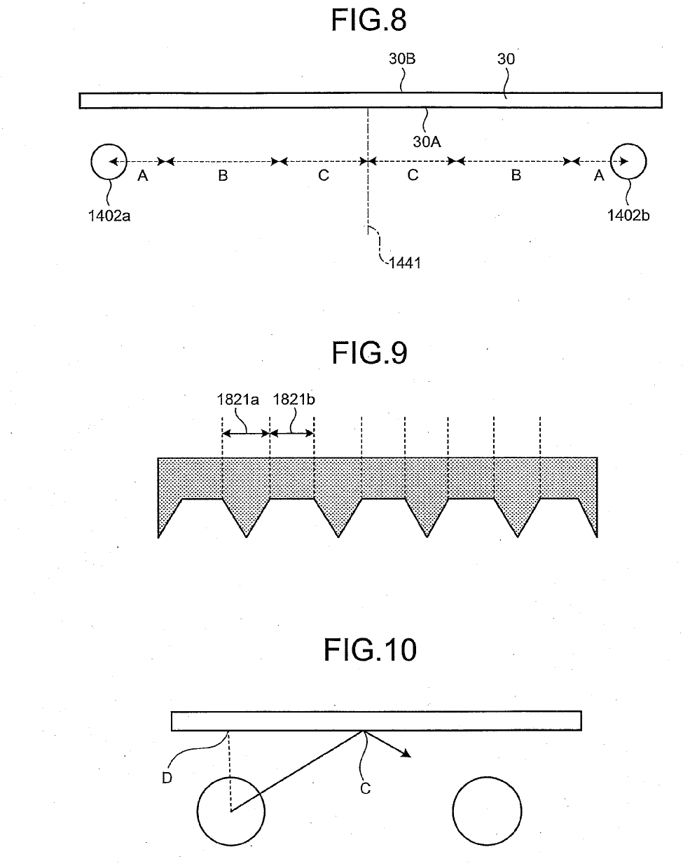

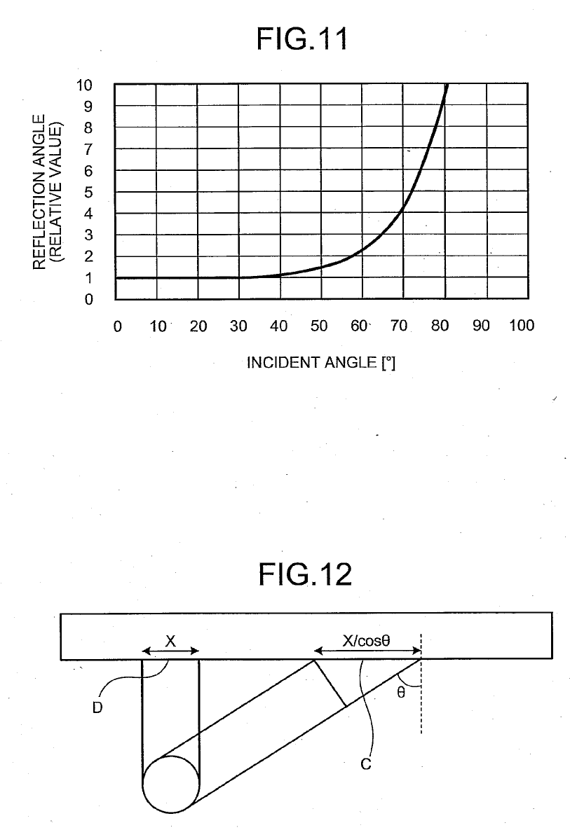

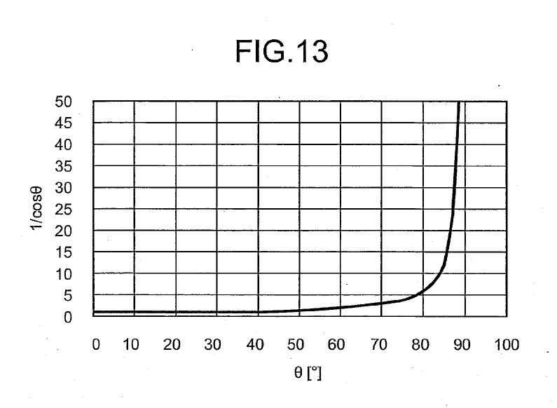

A direct-type backlight device was produced in the same manner as in Example 1, except that the concavo-convex structure pattern on the light diffusion plate was made as described below. The concavo-convex structure pattern on the light diffusion plate used in this Example will be explained with reference to FIG. 8. As shown in FIG. 8, a state wherein the light diffusion plate was mounted was considered. The midpoint of the distance from the center of the cold cathode tube 1402a to the center of the adjacent cold cathode tube 1402b was defined as midpoint 1441. Each of the distances from the midpoint 1441 to the center of the cold cathode tube 1402a and to the center of the cold cathode tube 1402b was segmented into three zones A (1.28 mm), B (1.26 mm) and C (8.96 mm).

In FIG. 8, the light incident surface 30A of the light diffusion plate 30 was entirely provided with prism convex portions having a cross-sectional surface shape of an isosceles triangle having an apex angle of 130° (arithmetic mean slope of 25°) and a bottom side length of 70 μm so that there was no flat gap (so that no flat portion existed, i.e., base angles of the adjacent triangles were mutually contacted).

Meanwhile, each zone on the light emitting surface 30B of the light diffusion plate 30 was constituted by the prisms shown in Table 3. The prism pitch in zone A was 64 μm and the prism pitch in zones B and C was 70 μm.

TABLE 3

Mix ratio

| | Width (mm) | 105° | 160° |
|---|---|---|---|
| A | 1.28 | 1 | 1 |
| B | 1.26 | 2 | 1 |
| C | 8.96 | 3 | 1 |

In this backlight device, the width of the region Y (r×(b+(a/2)²)^{1/2}/b) is 8.2 mm, a/b is 5.1, the maximum arithmetic mean slope of the prisms on the light incident surface in the region Y is 25°, and the maximum arithmetic mean slope of the prisms on the light emitting surface in the region Y is 37.5°. The resulting direct-type backlight device was evaluated as to the luminance and the luminance unevenness in the same manner as in Example 1. The results are shown in Table 3.

### Example 3

A direct-type backlight device was produced in the same manner as in Example 1, except that the concavo-convex structure pattern on the light diffusion plate was made as described below. The concavo-convex structure pattern on the light diffusion plate used in this Example will be explained with reference to FIG. 7. As shown in FIG. 7, a state wherein the light diffusion plate was mounted was considered. The midpoint of the distance from the center of the cold cathode tube 1402a to the center of the adjacent cold cathode tube 1402b was defined as midpoint 1441. Each of the distances from the midpoint 1441 to the center of the cold cathode tube 1402a and to the center of the cold cathode tube 1402b was segmented into three zones A (2.085 mm), B (3.92 mm) and C (5.495 mm).

In FIG. 7, the light emitting surface 30B in the light diffusion plate 30 was entirely provided with prisms having a cross-sectional surface shape of a triangle having an apex angle of 100° (arithmetic mean slope of 40°) and a bottom side length of 70 μm so that there was no flat gap (so that no flat portion existed, i.e., the base angles of the adjacent triangles were mutually contacted).

Meanwhile, each zone on the light incident surface 30A of the light diffusion plate 30 was constituted by the prisms shown below. Zone A was a flat surface. Zone B was provided in an alternate manner with prism convex portions 1821a having a cross-sectional surface shape of a triangle and a flat portions 1821b as shown in FIG. 9. The apex angle of the triangle-shaped convex portion 1821a was 130° (arithmetic mean slope of 25°), the bottom side length of the convex portion 1821a was 70 μm, and the width of the flat portion 1821b was 70 μm. Zone C was provided with prisms having a cross-sectional surface shape of a triangle having an apex angle of 130° (arithmetic mean slope of 25°) and the bottom side length of 70 μm with no flat gap portion.

In this backlight device, the width of the region Y (r×(b²+(a/2)²)^{1/2}/b) is 8.2 mm, a/b is 5.1, the maximum arithmetic mean slope of the prisms on the light incident surface in the region Y is 25°, and the maximum arithmetic mean slope of the prisms on the light emitting surface in the region Y is 40°. The resulting direct-type backlight device was evaluated as to the luminance and the luminance unevenness in the same manner as in Example 1. The results are shown in Table 2.

### Example 4

A direct-type backlight device was produced in the same manner as in Example 1, except that the concavo-convex structure pattern on the light diffusion plate was made as described below and the depth of the reflection plate was 10 mm. The light emitting surface of the light diffusion plate was entirely provided with prisms having a cross-sectional surface shape of a triangle having an apex angle of 130° (arithmetic mean slope of 25°) and the bottom side length of 70 μm so that there was no flat gap (so that no flat portion existed, i.e., the base angles of the adjacent triangles were mutually contacted). Meanwhile, the light incident surface of the light diffusion plate 30 was entirely provided with prisms having a cross-sectional surface shape of a triangle having an apex angle of 120° (arithmetic mean slope of 30°) and the bottom side length of 70 μm so that there was no flat gap (so that no flat portion existed, i.e., the base angles of the adjacent triangles were mutually contacted).

In this backlight device, the distance from the reflection plate to the center of the cold cathode tube was 3.5 mm. At that time, the distance “b” between the center of the cold cathode tube and the light incident surface of the light diffusion plate was 6.5 mm. The width of the region Y (r×(b²+(a/2)²)^{1/2}/b) is 6.1 mm, a/b is 3.5, the maximum arithmetic mean slope of the prisms on the light incident surface in the region Y is 30°, and the maximum arithmetic mean slope of the prisms on the light emitting surface in the region Y is 25°. The resulting direct-type backlight device was evaluated as to the luminance and the luminance unevenness in the same manner as in Example 1. The results are shown in Table 2.

### Example 5

A direct-type backlight device was produced in the same manner as in Example 1, except that the concavo-convex structure pattern on the light diffusion plate was made as described below, the depth of the reflection plate was 11 mm, the distance from the reflection plate to the center of the cold cathode tube was 5.0 mm, the distance between the centers of the cold cathode tubes was 24.5 mm and one additional diffusion sheet was placed on the top of the optical sheets.

The light emitting surface of the light diffusion plate was entirely provided with prisms having a cross-sectional surface shape of a triangle having an apex angle of 100° (arithmetic mean slope of 40°) and the bottom side length of 70 μm so that there was no flat gap (so that no flat portion existed, i.e., the base angles of the adjacent triangles were mutually contacted). Meanwhile, the light incident surface of the light diffusion plate 30 was entirely provided with prisms having a cross-sectional surface shape of a triangle having an apex angle of 130° (arithmetic mean slope of 25°) and the bottom side length of 70 μm so that there was no flat gap (so that no flat portion existed, i.e., the base angles of the adjacent triangles were mutually contacted).

In this backlight device, the distance “b” between the center of the cold cathode tube and the light incident surface of the light diffusion plate was 6.0 mm. The width of the region Y (r×(b²+(a/2)²)^{1/2}/b) is 6.8 mm, a/b is 4.1, the maximum arithmetic mean slope of the prisms on the light incident surface in the region Y is 25°, and the maximum arithmetic mean slope of the prisms on the light emitting surface in the region Y is 40°. The resulting direct-type backlight device was evaluated as to the luminance and the luminance unevenness in the same manner as in Example 1. The results are shown in Table 2.

### Example 6

A direct-type backlight device was produced in the same manner as in Example 5, except that the concavo-convex structure pattern on the light diffusion plate was made as described below. The light emitting surface of the light diffusion plate was entirely provided with prisms having a cross-sectional surface shape of a triangle having an apex angle of 105° (arithmetic mean slope of 37.5°) and the bottom side length of 70 μm so that there was no flat gap (so that no flat portion existed, i.e., the base angles of the adjacent triangles were mutually contacted). Meanwhile, the light incident surface of the light diffusion plate 30 was entirely provided with prisms having a cross-sectional surface shape of a triangle having an apex angle of 135° (arithmetic mean slope of 22.5°) and the bottom side length of 70 μm so that there was no flat gap (so that no flat portion existed, i.e., the base angles of the adjacent triangles were mutually contacted).

The width of the region Y (r×(b²+(a/2)²)^{1/2}/b) is 6.8 mm, a/b is 4.1, the maximum arithmetic mean slope of the prisms on the light incident surface in the region Y is 22.5°, and the maximum arithmetic mean slope of the prisms on the light emitting surface in the region Y is 37.5°. The resulting direct-type backlight device was evaluated as to the luminance and the luminance unevenness in the same manner as in Example 1. The results are shown in Table 2.

### Example 7

A direct-type backlight device was produced in the same manner as in Example 5, except that the concavo-convex structure pattern on the light diffusion plate was made as described below, the distance between the centers of the cold cathode tubes was 23 mm and four diffusion sheets (188GM3 supplied from Kimoto Co., Ltd.) and a reflection polarizer (DBEF-D supplied from Sumitomo 3M Ltd.) in this order from the light diffusion plate side were used as the optical sheets on the light diffusion plate.

The light emitting surface of the light diffusion plate was entirely provided with prisms having a cross-sectional surface shape of a triangle having an apex angle of 110° (arithmetic mean slope of 35°) and the bottom side length of 70 μm so that there was no flat gap (so that no flat portion existed, i.e., the base angles of the adjacent triangles were mutually contacted). Meanwhile, the light incident surface in the light diffusion plate 30 was entirely provided with prisms having a cross-sectional surface shape of a triangle having an apex angle of 130° (arithmetic mean slope of 25°) and the bottom side length of 70 μm so that there was no flat gap (so that no flat portion existed, i.e., the base angles of the adjacent triangles were mutually contacted).

The width of the region Y (r×(b²+(a/2)²)^{1/2}/b) is 6.1 mm, a/b is 3.5, the maximum arithmetic mean slope of the prisms on the light incident surface in the region Y is 25°, and the maximum arithmetic mean slope of the prisms on the light emitting surface in the region Y is 35°. The resulting direct-type backlight device was evaluated as to the luminance and the luminance unevenness in the same manner as in Example 1. The results are shown in Table 2.

### Example 8

A direct-type backlight device was produced in the same manner as in Example 7, except that the concavo-convex structure pattern on the light diffusion plate was made as described below and the diffusion sheet (188GM3 supplied from Kimoto Co., Ltd.), the reflection polarizer (DBEF-D supplied from Sumitomo 3M Ltd.) and the diffusion sheet (188GM3 supplied from Kimoto Co., Ltd.) in this order from the light diffusion plate side were used as the optical sheets on the light diffusion plate.

The light emitting surface in the light diffusion plate was entirely provided with prisms having a cross-sectional surface shape of a triangle having an apex angle of 120° (arithmetic mean slope of 30°) and the bottom side length of 70 μm so that there was no flat gap (so that no flat portion existed, i.e., the base angles of the adjacent triangles were mutually contacted). Meanwhile, the light incident surface in the light diffusion plate 30 was entirely provided with prisms having a cross-sectional surface shape of a triangle having an apex angle of 130° (arithmetic mean slope of 25°) and the bottom side length of 70 μm so that there was no flat gap (so that no flat portion existed, i.e., the base angles of the adjacent triangles were mutually contacted).

The width of the region Y (r×(b²+(a/2)²)^{1/2}/b) is 6.1 mm, a/b is 3.5, the maximum arithmetic mean slope of the prisms on the light incident surface in the region Y is 30°, and the maximum arithmetic mean slope of the prisms on the light emitting surface in the region Y is 25°. The resulting direct-type backlight device was evaluated as to the luminance and the luminance unevenness in the same manner as in Example 1. The results are shown in Table 2.

### Example 9

A light diffusion plate and a backlight device were produced in the same manner as in Example 1, except that the light diffusion plate was molded using the injection molding machine (mold clamping force: 9,810 KN) and using the alicyclic olefin polymer (Zeonor 1420R supplied from Zeon Corporation) as the raw material under the conditions of the cylinder temperature at 320° C., the pressure keeping at 75 MPa, the pressure keeping time for 6 seconds and the mold temperature at 120° C. The surface of the triangle prism having the apex angle of 100° on this light diffusion plate was polished and a residual stress was measured, and its maximum value was 13 MPa. The resulting direct-type backlight device was evaluated as to the luminance and the luminance unevenness in the same manner as in Example 1. The luminance was 5,720 cd/m² and the luminance unevenness was 0.5%. The results are shown in Table 2. After the measurement, the observation was continued with lighting the backlight, and the luminance unevenness was increased up to 1.5% one hour after turning on the device.

### Comparative Example 1

A light diffusion plate and a direct-type backlight device were produced in the same manner as in Example 1, except that the light diffusion plate has no prism on both main surfaces, and merely traces of cutting upon preparing the mold was transferred onto the surfaces. The roughness and the mean slope on both main surfaces of the light diffusion plate were measured, and Ra was 0.5 μm and the maximum arithmetic mean slope was 13°. The resulting direct-type backlight device was evaluated as to the luminance and the luminance unevenness in the same manner as in Example 1. The luminance was 4,880 cd/m² and the luminance unevenness was 2.7%. The results are shown in Table 4.

TABLE 4

| | | Unit | Comp. Ex. 1 | Comp. Ex. 2 | Comp. Ex. 3 | Comp. Ex. 4 |
|---|---|---|---|---|---|---|
| Back- | Distance between | mm | 23.0 | 23.0 | 23.0 | 23.0 |
| light | centers of linear light | | | | | |
| con- | sources “a” | | | | | |
| struc- | Distance between linear | mm | 4.5 | 4.5 | 4.5 | 4.5 |
| tion | light source center and | | | | | |
| | light incident surface | | | | | |
| | “b” | | | | | |
| | Distance between | mm | 3.5 | 3.5 | 3.5 | 3.5 |
| | liniear light source | | | | | |
| | center and reflection | | | | | |
| | plate “d” | | | | | |
| | Distance between light | mm | 8.0 | 8.0 | 8.0 | 8.0 |
| | incident surface and | | | | | |
| | reflection plate | | | | | |
| | Outer diameter of | mm | 4.0 | 4.0 | 4.0 | 4.0 |
| | linear light source “R” | | | | | |
| | Inner diameter of | mm | 3.0 | 3.0 | 3.0 | 3.0 |
| | linear light source “r” | | | | | |
| | Optical sheet 1 | — | None | None | None | None |
| | (distant from light | | | | | |
| | diffusion plate) | | | | | |
| | Optical sheet 2 | — | None | None | None | None |
| | Optical sheet 3 | — | Diffusion | Diffusion | Diffusion | Diffusion |
| | | | sheet | sheet | sheet | sheet |
| | Optical sheet 4 | — | Prism | Prism | Prism | Prism |
| | | | sheet | sheet | sheet | sheet |
| | Optical sheet 5 (near | — | Diffusion | Diffusion | Diffusion | Diffusion |
| | light diffusion plate) | | sheet | sheet | sheet | sheet |
| Light | Light emitting surface | ° | None | 100° | None | None |
| diffu- | pattern | | | | | |
| sion | Light incident surface | ° | None | None | 100 | 50 |
| plate | pattern | | | | | |
| | Region Y (light | ° | 13 | 40 | 13 | 13 |
| | emitting) maximum slope | | | | | |
| | Region Y (light | ° | 13 | 13 | 40 | 65 |
| | incident) maximum slope | | | | | |
| | r × (b² + (a/2)2)¹/²/b | mm | 8.2 | 8.2 | 8.2 | 8.2 |
| | Residual stress | MPa | 0.3 | 0.3 | 0.3 | 0.3 |
| Re- | Luminance | cd/m² | 4880 | 5550 | 5600 | 4750 |
| sults | Luminance unevenness | % | 2.7 | 2.0 | 5.0 | 2.5 |

### Comparative Example 2

A light diffusion plate and a direct-type backlight device were produced in the same manner as in Comparative Example 1, except that the light emitting surface in the light diffusion plate was entirely provided with prisms having a cross-sectional surface shape of a triangle having an apex angle of 100° (arithmetic mean slope of 40°) and the bottom side length of 70 μm so that there was no flat gap (so that no flat portion existed, i.e., the base angles of the adjacent triangles were mutually contacted). The maximum arithmetic mean slope on the light emitting surface of the light diffusion plate is 40°. The resulting direct-type backlight device was evaluated as to the luminance and the luminance unevenness in the same manner as in Example 1. The results are shown in Table 4.

### Comparative Example 3

A light diffusion plate and a direct-type backlight device were produced in the same manner as in Comparative Example 1, except that the light incident surface in the light diffusion plate was entirely provided with prisms having a cross-sectional surface shape of a triangle having an apex angle of 100° (arithmetic mean slope of 40°) and the bottom side length of 70 μm so that there was no flat gap (so that no flat portion existed, i.e., the base angles of the adjacent triangles were mutually contacted). The maximum arithmetic mean slope on the light incident surface of the light diffusion plate is 40°. The resulting direct-type backlight device was evaluated as to the luminance and the luminance unevenness in the same manner as in Example 1. The results are shown in Table 4.

### Comparative Example 4

A light diffusion plate and a direct-type backlight device were produced in the same manner as in Comparative Example 1, except that the light incident surface in the light diffusion plate was entirely provided with prisms having a cross-sectional surface shape of a triangle having an apex angle of 50° (arithmetic mean slope of 65°) and the bottom side length of 70 μm so that there was no flat gap (so that no flat portion existed, i.e., the base angles of the adjacent triangles were mutually contacted). The maximum arithmetic mean slope on the light incident surface of the light diffusion plate is 65°. The resulting direct-type backlight device was evaluated as to the luminance and the luminance unevenness in the same manner as in Example 1. The results are shown in Table 4.

Although the present invention has been described with reference to the preferred examples, it should be understood that various modifications and variations can be easily made by those skilled in the art without departing from the spirit of the invention. Accordingly, the foregoing disclosure should be interpreted as illustrative only and is not to be interpreted in a limiting sense. The present invention is limited only by the scope of the following claims along with their full scope of equivalents.

What is claimed is:

1. A light diffusion plate for disposing on a light emitting side of a light source, a planar view of said light diffusion plate being a rectangular shape, said light diffusion plate comprising:
a plurality of regions X residing at an interval of “a” (mm) along a short side direction of said light diffusion plate, each of said region X having a width along said short side direction of 1.5 to 8.0 (mm), having a center position D of said width direction, and extending along a long side direction of said light diffusion plate,
a region Y whose center is located at a position C which is the center position between the adjacent position D's, said region Y having a width along said short side direction of (0.1×a) to (0.6×a) (mm) and extending along a long side direction of said light diffusion plate, and
a region Z between said region X and said region Y,
wherein a main surface A of said light diffusion plate includes a region AX corresponding to said region X, a region AY corresponding to said region Y, and a region AZ corresponding to said region Z,
wherein another main surface B of said light diffusion plate includes a region BX corresponding to said region X, a region BY corresponding to said region Y, and a region BZ corresponding to said region Z,
wherein a prism array XAA is formed on said region AX, wherein said prism array XAA is composed of a plurality of linear prisms XA arranged approximately in parallel, extending along said long side direction of said light diffusion plate,
wherein a prism array YBB is formed on said region BY, wherein said prism array YBB is composed of a plurality of linear prisms YB arranged approximately in parallel, extending along said long side direction of said light diffusion plate, and
wherein, among said plurality of linear prisms YB constituting said prism array YBB, each of said linear prisms YB has a maximum arithmetic mean slope of 3 to 50°, said mean slope being with respect to a plain surface which is perpendicular to a thickness direction of said light diffusion plate.

2. The light diffusion plate according to claim 1, wherein each of said linear prism XA and said linear prism YB has a cross-sectional surface shape of curved or polygonal configuration, said cross-sectional surface being perpendicular to a lengthwise direction of each prism.

3. The light diffusion plate according to claim 2,
wherein said cross-sectional surface shape is symmetric about an axis, said axis being in parallel with a thickness direction of said light diffusion plate.

4. The light diffusion plate according to claim 1,
wherein a prism array YAA is formed on said region AY, wherein said prism array YAA is composed of a plurality of convex linear prisms YA arranged approximately in parallel and extending along said long side direction of said light diffusion plate, and
wherein a maximum arithmetic mean slope on said linear prism YA which composes said prism array YAA is larger than a maximum arithmetic mean slope on said linear prism YB which composes said prism array YBB.

5. The light diffusion plate according to claim 1,
wherein a prism array YAA is formed on said region AY, wherein said prism array YAA is composed of a plurality of convex linear prisms YA arranged approximately in parallel and extending along said long side direction of said light diffusion plate, and
wherein a shape of said prism array YAA and a shape of said prism array XAA are different from each other.

6. The light diffusion plate according to claim 1,
wherein a prism array YAA is formed on said region AY, wherein said prism array YAA is composed of a plurality of convex linear prisms YA arranged approximately in parallel and extending along said long side direction of said light diffusion plate,
wherein a prism array ZAA is formed on said region AZ, wherein said prism array ZAA is composed of a plurality of convex linear prisms ZA arranged approximately in parallel and extending along said long side direction of said light diffusion plate, and
wherein said linear prism XA, said linear prism YA and said linear prism ZA have the same shape as one another.

7. The light diffusion plate according to claim 1,
wherein a prism array XBB is formed on said region BX, wherein said prism array XBB is composed of a plurality of convex linear prisms XB arranged approximately in parallel and extending along said long side direction of said light diffusion plate, and
wherein a shape of said prism array YBB and a shape of said prism array XBB are different from each other.

8. The light diffusion plate according to claim 1,
wherein a prism array XBB is formed on said region BX, wherein said prism array XBB is composed of a plurality of convex linear prisms XB arranged approximately in parallel and extending along said long side direction of said light diffusion plate,
wherein a prism array ZBB is formed on said region BZ, wherein said prism array ZBB is composed of a plurality of convex linear prisms ZB arranged approximately in parallel and extending along said long side direction of said light diffusion plate, and
wherein said linear prism XB, said linear prism YB and said linear prism ZB have the same shape as one another.

9. The light diffusion plate according to claim 1,
wherein a prism array XBB is formed on said region BX, wherein said prism array XBB is composed of a plurality of convex linear prisms XB arranged approximately in parallel and extending along said long side direction of said light diffusion plate,
wherein a prism array ZBB is formed on said region BZ, wherein said prism array ZBB is composed of a plurality of convex linear prisms ZB arranged approximately in parallel and extending along said long side direction of said light diffusion plate,
wherein at least one of said prism array XBB, said prism array YBB and said prism array ZBB includes two or more types of linear prisms each having a different arithmetic mean slope from another, and
wherein an existence ratio of said two or more types of linear prisms is arranged so that the ratio of said linear prisms having a larger arithmetic mean slope is increased continuously or stepwisely as a distance from the center position in a width direction of said region BX is increased.

10. The light diffusion plate according to claim 1,
wherein a prism array XBB is formed on said region BX, wherein said prism array XBB is composed of a plurality of convex linear prisms XB arranged approximately in parallel and extending along said long side direction of said light diffusion plate,
wherein a prism array ZBB is formed on said region BZ, wherein said prism array ZBB is composed of a plurality of convex linear prisms ZB arranged approximately in parallel and extending along said long side direction of said light diffusion plate, and
wherein at least one of said prism array XBB, said prism array YBB and said prism array ZBB is provided so that the arithmetic mean slope of said linear prism is increased continuously or stepwisely as a distance from the center position in a width direction of said region BX is increased and a distance toward said position C is decreased.

11. The light diffusion plate according to claim 1,
wherein a prism array YAA is formed on said region AY, wherein said prism array YAA is composed of a plurality of convex linear prisms YA arranged approximately in parallel and extending along said long side direction of said light diffusion plate,
wherein a prism array ZAA is formed on said region AZ, wherein said prism array ZAA is composed of a plurality of convex linear prisms ZA arranged approximately in parallel and extending along said long side direction of said light diffusion plate,
wherein at least one of said prism array XAA, said prism array YAA and said prism array ZAA includes two or more types of linear prisms having a different arithmetic mean slope, and
wherein an existence ratio of said two or more types of linear prisms is arranged so that the ratio of said linear prisms having a larger arithmetic mean slope is increased continuously or stepwisely as a distance from the center position in a width direction of said region AX is increased.

12. The light diffusion plate according to claim 1,
wherein a prism array YAA is formed on said region AY, wherein said prism array YAA is composed of a plurality of convex linear prisms YA arranged approximately in parallel and extending along said long side direction of said light diffusion plate,
wherein a prism array ZAA is formed on said region AZ, wherein said prism array ZAA is composed of a plurality of convex linear prisms ZA arranged approximately in parallel and extending along said long side direction of said light diffusion plate, and
wherein at least one of said prism array XAA, said prism array YAA and said prism array ZAA is arranged so that the arithmetic mean slope of said linear prism is increased continuously or stepwisely as a distance from the center position in a width direction of said region AX is increased and a distance toward said position C is decreased.

13. A direct-type backlight device comprising a reflection plate, a plurality of linear light sources disposed approximately in parallel to one another, and the light diffusion plate according to claim 1 disposed on a light emitting side of said linear light source, wherein said linear light source is disposed in a position opposed to said region BX.

14. A liquid crystal display device comprising the direct-type backlight device according to claim 13 and a liquid crystal panel disposed on a light emitting side of this direct-type backlight device.
